(19) United States
(12) Patent Application Publication
(10) Pub. No.: US 2025/0106713 A1
(43) Pub. Date: Mar. 27, 2025

(54) METHOD AND APPARATUS OF PERFORMING UE BASED UPLINK TIMING ADJUSTMENT FOR LAYER 1/2 TRIGGERED MOBILITY IN THE NEXT COMMUNICATION SYSTEMS

(71) Applicant: Samsung Electronics Co., Ltd., Suwon-si (KR)

(72) Inventors: Seungri JIN, Suwon-si (KR); Sangkyu BAEK, Suwon-si (KR); June HWANG, Suwon-si (KR)

(21) Appl. No.: 18/825,480

(22) Filed: Sep. 5, 2024

(30) Foreign Application Priority Data
Sep. 26, 2023 (KR) 10-2023-0128999

(51) Int. Cl. H04W 36/04; H04W 36/00; H04W 36/08; H04W 56/00; H04W 76/20; H04W 80/02

(52) U.S. Cl. CPC H04W 36/04; H04W 36/00725; H04W 36/008355; H04W 36/08; H04W 56/0045; H04W 76/20; H04W 80/02

(57) ABSTRACT

A method performed by a user equipment (UE) in a wireless communication system is provided. The method includes receiving, from a base station, layer 1/layer 2 triggered mobility (LTM) configuration information including a configuration for at least one candidate cell via a radio resource control (RRC) message, wherein the configuration includes information associated with UE-based timing advance (TA) measurement configured for a candidate cell, identifying that the UE-based TA measurement is configured for the candidate cell of the at least one candidate cell, based on the information, receiving, from the base station, a medium access control (MAC) control element (CE) indicating a LTM cell switch, the MAC CE including first information indicating a configuration identity (ID) of the candidate cell for the LTM cell switch and second information on a timing advance command, identifying whether a valid timing advance (TA) value is indicated based on the timing advance command, and in case that the valid TA value is indicated based on the timing advance command, applying the TA value for the LTM cell switch to the candidate cell.

### CROSS-REFERENCE TO RELATED APPLICATION(S)

This application is based on and claims priority under 35 U.S.C. § 119 (a) of a Korean patent application number 10-2023-0128999, filed on Sep. 26, 2023, in the Korean Intellectual Property Office, the disclosure of which is incorporated by reference herein in its entirety.

### BACKGROUND

### 1. Field

The disclosure relates to a method and apparatus for adjusting uplink timing in layer 1/layer 2 triggered mobility (LTM).

### 2. Description of Related Art

Generally, 5th generation (5G) mobile communication technologies define broad frequency bands such that high transmission rates and new services are possible, and can be implemented not only in “Sub 6 gigahertz (GHz)” bands such as 3.5 GHZ, but also in “Above 6 GHz” bands referred to as millimeter wave (mmWave) including 28 GHz and 39 GHz. In addition, it has been considered to implement 6th generation (6G) mobile communication technologies, which is referred to as Beyond 5G systems, in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra-reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of band-width part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

A cell serving a UE may indicate the corresponding UE to handover to another cell based on the measurement report of the corresponding UE. In this case, the UE performs a separate random access procedure, etc. for uplink synchronization with the new cell, and thus an interruption may occur, delaying the handover procedure.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus capable of alleviating interruption to uplink transmission to a target cell when the UE performs L1/L2 triggered mobility (LTM) handover.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving, from a base station, layer 1/layer 2 triggered mobility (LTM) configuration information including a configuration for at least one candidate cell via a radio resource control (RRC) message, wherein the configuration includes information associated with UE-based timing advance (TA) measurement configured for a candidate cell, identifying that the UE-based TA measurement is configured for the candidate cell of the at least one candidate cell, based on the information, receiving, from the base station, a medium access control (MAC) control element (CE) indicating a LTM cell switch, the MAC CE including first information indicating a configuration identity (ID) of the candidate cell for the LTM cell switch and second information on a timing advance command, identifying whether a valid timing advance (TA) value is indicated based on the timing advance command, and in case that the valid TA value is indicated based on the timing advance command, applying the TA value for the LTM cell switch to the candidate cell.

In accordance with another aspect of the disclosure, a method performed by a base station in a wireless communication system is provided. The method includes transmitting, to a user equipment (UE), layer 1/layer 2 triggered mobility (LTM) configuration information including a configuration for at least one candidate cell via a radio resource control (RRC) message, wherein the configuration includes information associated with UE-based timing advance (TA) measurement configured for a candidate cell, and transmitting, to the UE, a medium access control (MAC) control element (CE) indicating a LTM cell switch, the MAC CE including first information indicating a configuration identity (ID) of the candidate cell for the LTM cell switch and second information on a timing advance command, wherein the UE-based TA measurement is configured with the UE for the candidate cell of the at least one candidate cell based on the information, and wherein, in case that a valid timing advance (TA) value is indicated based on the timing advance command, the valid TA value is applied by the UE for the LTM cell switch to the candidate cell.

In accordance with another aspect of the disclosure, a user equipment (UE) in a wireless communication system is provided. The UE includes a transceiver and a controller configured to control the transceiver to receive, from a base station, layer 1/layer 2 triggered mobility (LTM) configuration information including a configuration for at least one candidate cell via a radio resource control (RRC) message, wherein the configuration includes information associated with UE-based timing advance (TA) measurement configured for a candidate cell, identify that the UE-based TA measurement is configured for the candidate cell of the at least one candidate cell, based on the information, control the transceiver to receive, from the base station, a medium access control (MAC) control element (CE) indicating a LTM cell switch, the MAC CE including first information indicating a configuration identity (ID) of the candidate cell for the LTM cell switch and second information on a timing advance command, identify whether a valid timing advance (TA) value is indicated based on the timing advance command, and in case that the valid TA value is indicated based on the timing advance command, apply the TA value for the LTM cell switch to the candidate cell.

In accordance with another aspect of the disclosure, a base station in a wireless communication system is provided. The base station includes a transceiver and a controller configured to control the transceiver to transmit, to a user equipment (UE), layer 1/layer 2 triggered mobility (LTM) configuration information including a configuration for at least one candidate cell via a radio resource control (RRC) message, wherein the configuration includes information associated with UE-based timing advance (TA) measurement configured for a candidate cell, and control the transceiver to transmit, to the UE, a medium access control (MAC) control element (CE) indicating a LTM cell switch, the MAC CE including first information indicating a configuration identity (ID) of the candidate cell for the LTM cell switch and second information on a timing advance command, wherein the UE-based TA measurement is configured with the UE for the candidate cell of the at least one candidate cell based on the information, and wherein, in case that a valid timing advance (TA) value is indicated based on the timing advance command, the valid TA value is applied by the UE for the LTM cell switch to the candidate cell.

According to an embodiment of the disclosure, the UE acquires a timing advance (TA) of a target cell based on the TA of a current serving cell by using received signal time difference of downlink reference signals of a source cell and target cell. This enables the UE to not perform random access during handover to the target cell, thereby reducing an uplink interruption time.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating the structure of a next-generation mobile communication system according to an embodiment of the disclosure;

FIG. 2 is a diagram illustrating the structure of a wireless protocol of a next-generation mobile communication system according to an embodiment of the disclosure;

FIG. 3 is a diagram illustrating the structure of another next-generation mobile communication system according to an embodiment of the disclosure;

FIG. 4 is a diagram illustrating an operation in which a UE changes a serving cell and beam to a TRP of a target cell that supports L1/L2-based cell change, and transmits and receives data, as an L1/L2 triggered mobility (LTM) scenario according to an embodiment of the disclosure;

FIG. 5 is a diagram illustrating a scenario in which a UE autonomously updates TA by using received signal time difference of downlink reference signals of a source cell and target cell based on a TA value of a source cell, according to an embodiment of the disclosure;

FIG. 6 is a diagram illustrating a procedure in which a UE is indicated to perform LTM cell switch and UE-based uplink TA acquisition for a target cell together, according to an embodiment of the disclosure;

FIG. 7 is a diagram illustrating a procedure in which a UE is indicated to perform UE-based uplink TA acquisition for a target cell before the UE is indicated with LTM cell switch, according to an embodiment of the disclosure;

FIG. 8 is a diagram illustrating a procedure in which a UE is indicated to perform UE-based uplink TA acquisition for a target cell according to a previously configured condition before the UE is indicated with LTM cell switch, according to an embodiment of the disclosure;

FIG. 9 is a diagram illustrating a UE operation according to an embodiment of the disclosure;

FIG. 10 is a diagram illustrating a base station operation according to an embodiment of the disclosure;

FIG. 11 is a block diagram illustrating an internal structure of a UE according to an embodiment of the disclosure; and

FIG. 12 is a block diagram illustrating a constitution of a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For convenience of description, in the disclosure, terms and names defined in 3rd Generation Partnership Project Long Term Evolution (3GPP LTE) standard are used. However, the disclosure is not restricted by the terms and names, and may be identically applied to systems complying with other standards.

In addition, for convenience of description, in the disclosure, layer 1/layer 2 (L1/L2)-based mobility support will be described interchangeably with terms such as L1/L2 handover, L1/L2 triggered mobility (LTM), or L1/L2 triggered mobility.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

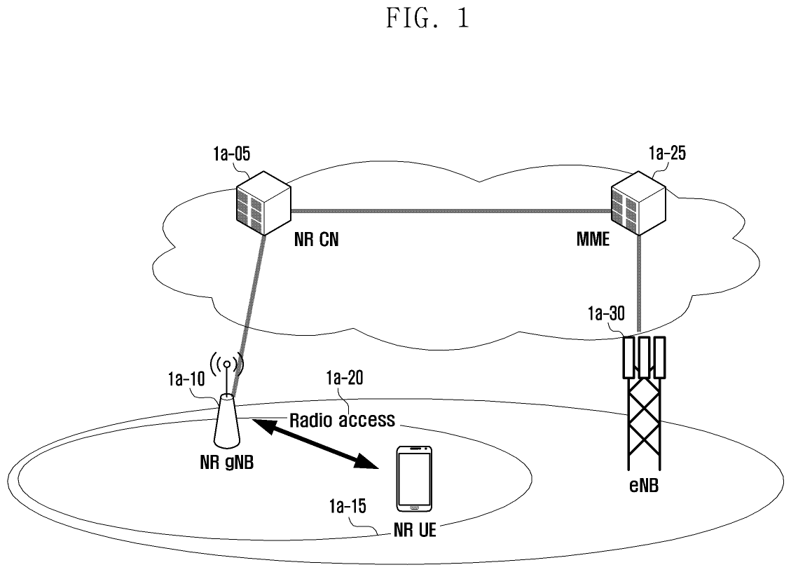

FIG. 1 is a diagram illustrating the structure of a next-generation mobile communication system according to an embodiment of the disclosure.

Referring to FIG. 1, as illustrated, a wireless access network of a next-generation mobile communication system is constituted to include a new radio node B (hereinafter, referred to as NR NB) 1a-10 and a new radio core network (NR CN: next generation core network) 1a-05. New radio user equipment (hereinafter, referred to as NR UE or a terminal) 1a-15 accesses an external network through the NR gNB 1a-10 and the NR CN 1a-05.

Referring to FIG. 1, the NR gNB 1a-10 corresponds to an evolved node B (eNB) of an existing LTE system. The NR gNB 1a-10 may be connected to the NR UE 1a-15 through a wireless channel, and may provide services superior to those of the existing node B. In the next-generation mobile communication system, since all user traffic is served through a shared channel, a device for collecting status information, such as buffer status, available transmission power status, and channel status of UEs, and performing scheduling is required. The NR gNB 1a-10 serves as such a device. One NR gNB typically controls multiple cells. In order to realize super-high data rates compared to the existing long term evolution (LTE), the NR gNB may have a bandwidth equal to or greater than the maximum bandwidth of the existing system, may employ, as wireless access technology, orthogonal frequency division multiplexing (hereinafter, referred to as OFDM), and may further employ a beamforming technique. In addition, an adaptive modulation and coding (hereinafter, referred to as AMC) scheme is applied to determine a modulation scheme and a channel coding rate in accordance with the channel status of the UE.

The NR CN 1a-05 performs functions such as mobility support, bearer configuration, and Quality of Service (QOS) configuration. The NR CN 1a-05 is a device that performs various control functions, as well as a mobility management function for the UE, and is connected to a plurality of base stations. In addition, the next-generation mobile communication system may interwork with the existing LTE system, and the NR CN 1a-05 is connected to a mobility management entity (MME) 1a-25 through a network interface. The MME 1a-25 is connected to the eNB 1a-30, which is an existing base station.

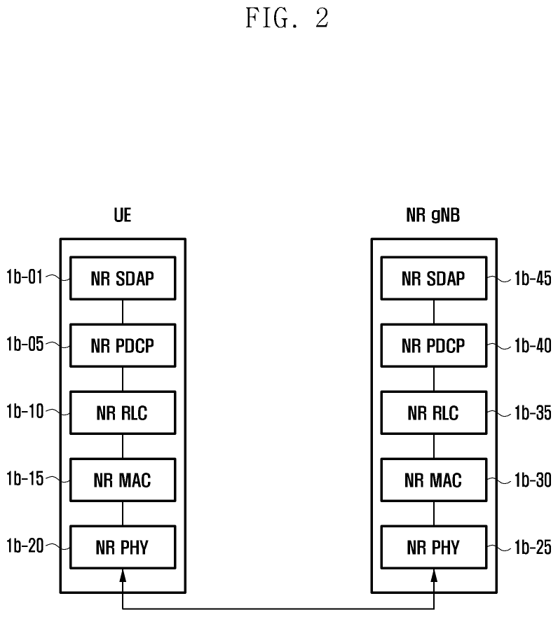

FIG. 2 is a diagram illustrating the structure of a wireless protocol of a next-generation mobile communication system according to an embodiment of the disclosure.

Referring to FIG. 2, the wireless protocol of the next-generation mobile communication system includes NR service data adaptation protocols (SDAPs) 1b-01 and 1b-45, NR packet data convergence protocols (PDCPs) 1b-05 and 1b-40, NR radio link controls (RLCs) 1b-10 and 1b-35, and NR medium access controls (MACs) 1b-15 and 1b-30 in the UE and the NR base station.

The main functions of the NR SDAPs 1b-01 and 1b-45 may include some of the following functions.
User data delivery function (transfer of user plane data)
Function of mapping QoS flow and a data bearer for uplink and downlink (mapping between a QoS flow and a DRB for both downlink (DL) and Uplink (UL)
Function of marking a QoS flow ID for uplink and downlink (marking QoS flow ID in both DL and UL packets)
Function of mapping reflective QoS flow to a data bearer for uplink SDAP PDUs (reflective QoS flow to DRB mapping for the UL SDAP PDUs).

With respect to the SDAP layer entity, the UE may be configured as to whether to use a header of the SDAP layer entity or a function of the SDAP layer entity for each PDCP layer entity, each bearer, or each logical channel through a radio resource control (RRC) message. In a case where the SDAP header is configured, a 1-bit indicator of non-access stratum (NAS) reflective QoS of the SDAP header and a 1 bit-indicator of access stratum (AS) reflective QoS may indicate that the UE updates or reconfigures information on mapping of QoS flow and a data bearer in uplink and downlink. The SDAP header may include QoS flow identifier (ID) information indicating the QoS. The QoS information may be used as data-processing-priority, scheduling information, etc. to support a seamless service.

The main functions of the NR PDCPs 1b-05 and 1b-40 may include some of the following functions.
Header compression and decompression function (Header compression and decompression: ROHC only)
User data transmission function (Transfer of user data)
Sequential delivery function (In-sequence delivery of upper layer PDUs)
Non-sequential delivery function (Out-of-sequence delivery of upper layer PDUs)
Reordering function (PDCP PDU reordering for reception)
Duplicate detection function (Duplicate detection of lower layer SDUs)
Retransmission function (Retransmission of PDCP SDUS)
Ciphering and deciphering function (Ciphering and deciphering)
Timer-based SDU discard function (Timer-based SDU discard in uplink.)

The reordering function of the NR PDCP layer entity is a function of sequentially reordering PDCP protocol data units (PDUs) received by a lower layer on the basis of a PDCP Sequence Number (SN), and may include a function of sequentially delivering the reordered data to a higher layer, a function of directly delivering the recorded data without considering the order, a function of recording PDCP PDUs lost due to the reordering, a function of reporting statuses of the lost PDCP PDUs to a transmitting side, and a function of making a request for retransmitting the lost PDCP PDUs.

The main functions of the NR RLCs 1b-10 and 1b-35 may include some of the following functions.
Data transmission function (Transfer of upper layer PDUs)
Sequential delivery function (In-sequence delivery of upper layer PDUs)
Non-sequential delivery function (Out-of-sequence delivery of upper layer PDUs).
ARQ function (Error Correction through ARQ)
Concatenation, segmentation, and reassembly function (Concatenation, segmentation and reassembly of RLC SDUs)
Re-segmentation function (Re-segmentation of RLC data PDUs)
Reordering function (Reordering of RLC data PDUs)
Duplicate detection function (Duplicate detection)
Error detection function (Protocol error detection)
RLC SDU discard function (RLC SDU discard)
RLC re-establishment function (RLC re-establishment)

The sequential delivery function (In-sequence delivery) of the NR RLC layer entity is a function of sequentially delivering RLC service data units (SDUs) received from a lower layer to a higher layer, and may include, in a case where one original RLC SDU is divided into a plurality of RLC SDUs and then received, a function of reassembling and delivering the RLC SDUs, a function of reordering the received RLC PDUs on the basis of an RLC Sequence Number (SN) or a PDCP sequence number (SN), a function of recording RLC PDUs lost due to the reordering, a function of reporting statuses of the lost RLC PDUs to a transmitting side, a function of making a request for retransmitting the lost RLC PDUs, a function of, in a case where there is a lost RLC SDU, sequentially delivering only RLC SDUs preceding the lost RLC SDU to the higher layer, a function of, if a predetermined timer expires even though there is a lost RLC SDU, sequentially delivering all RLC SDUs received before the timer starts to the higher layer, or a function of, if a predetermined timer expires even though there is a lost RLC SDU, sequentially delivering all RLC SDUs received up to that point in time to the higher layer. Further, the NR RLC layer entity may process the RLC PDUs sequentially in a reception order thereof (according to an arrival order regardless of a serial number or a sequence number) and may deliver the RLC PDUs to the PDCP layer entity regardless of the sequence thereof (out-of-sequence delivery). In the case of segments, the NR RLC layer entity may receive segments which are stored in the buffer or will be received in the future, reconstitute the segments to be one RLC PDU, process the RLC PDU, and then deliver the same to the PDCP layer entity. The NR RLC layer may not include a concatenation function, and the function may be performed by the NR MAC layer, or may be replaced with a multiplexing function of the NR MAC layer.

The non-sequential delivery function (Out-of-sequence delivery) of the NR RLC layer entity is a function of delivering the RLC SDUs received from a lower layer directly to a higher layer regardless of the sequence of the RLC SDUs, and may include, in a case where one original RLC SDU is divided into a plurality of RLC SDUs and then received, a function of reassembling and delivering the RLC PDUs and a function of storing RLC SNs or PDCP SNs of the received RLC PDUs, reordering the RLC PDUs, and recording lost RLC PDUS.

The NR MACs 1b-15 and 1b-30 may be connected to a plurality of NR RLC layer entities constituted in one UE, and the main functions of the NR MACs may include some of the following functions.
Mapping function (Mapping between logical channels and transport channels)
Multiplexing and demultiplexing function (Multiplexing/demultiplexing of MAC SDUs)
Scheduling information report function (Scheduling information reporting).
HARQ function (Error correction through HARQ)
Priority handling function between logical channels (Priority handling between logical channels of one UE)
Priority handling function between UEs (Priority handling between UEs by means of dynamic scheduling)
MBMS service identification function (MBMS service identification)
Transport format selection function (Transport format selection)
Padding function (Padding)

The NR PHY layers 1b-20 and 1b-25 may perform an operation for channel-coding and modulating higher-layer data to generate an orthogonal frequency division multiplexing (OFDM) symbol and transmitting the OFDM symbol through a radio channel or demodulating and channel-decoding the OFDM symbol received through the radio channel and delivering the demodulated and channel-decoded OFDM symbol to the higher layer.

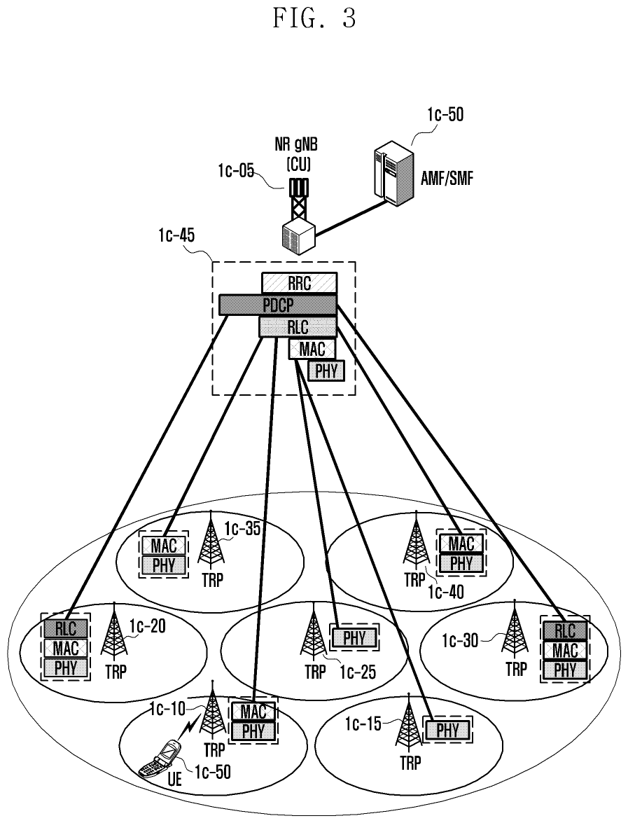

FIG. 3 is a diagram illustrating the structure of another next-generation mobile communication system according to an embodiment of the disclosure.

Referring to FIG. 3, a cell serviced by an NR gNB 1c-05 that operates based on beams may be constituted to include a plurality of transmission reception points (TRPs) 1c-10, 1c-15, 1c-20, 1c-25, 1c-30, 1c-35, and 1c-40. The TRPs 1c-10 to 1c-40 refer to blocks constituted by separating some functions for transmitting/receiving physical signals from existing NR base stations (eNBs), and include multiple antennas. The NR gNB 1c-05 may be expressed as a central unit (CU), and the TRP may be expressed as distributed unit (DU). Functions of the NR gNB 1c-05 and the TRP may be constituted by separating respective layers from a PDCP/RLC/MAC/PHY layer as 1c-45. That is, the TRP may perform a function of the corresponding layer only with the PHY layer (1c-15 and 1c-25), the TRP may perform the function of the corresponding layers only with the PHY layer and the MAC layer (1c-10, 1c-35, and 1c-40), and the TRP may perform the function of the corresponding layers only with the PHY layer, the MAC layer, and the RLC layer (1c-20 and 1c-30). Particularly, the TRPs 1c-10 to 1c-40 may use a beamforming technology of transmitting/receiving data by generating narrow beams in multiple directions by using multiple transmitting/receiving antennas.

The UE 1c-50 accesses the NR gNB 1c-05 and an external network through the TRPs 1c-10 to 1c-40. In order to provide users with a service, the NR gNB 1c-05 aggregates and schedules status information, such as the buffer status of UEs, the available transmission power status, and channel status, thereby supporting connection between the UEs and a core network (CN), particularly, an access and mobility management function (AMF)/session management function (SMF) 1c-50.

The TRP in the disclosure is based on a structures (1c-15 and 1c-25) that may perform the function of the corresponding layer with only the PHY layer.

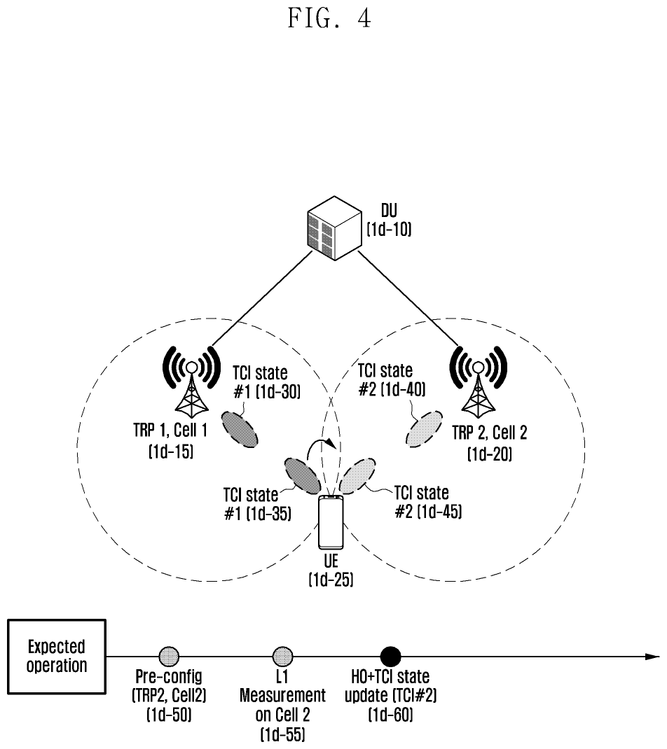

FIG. 4 is a diagram illustrating a scenario in which a UE changes a serving cell and beam to a TRP of a target cell that supports L1/L2-based cell change, and transmits and receives data, as an L1/L2 triggered mobility (LTM) scenario according to an embodiment of the disclosure.

In this diagram, a case in which a plurality of cells (TRP1-Cell1, TRP2-Cell2) 1d-15 and 1d-20 exist in one distributed unit (DU) 1d-10 is illustrated as an example, but the overall content of the disclosure may also be applied to the case of inter-DU (each DU constitutes one TRP-Cell).

Referring to FIG. 4, the UE may receive common configuration information and dedicated configuration information for an LTM candidate cell (TRP 2-Cell 2) 1d-20 through RRC configuration information from a serving cell 1d-15 (1d-50). That is, overall RRC configuration information such as cell group configuration (including ServingCellConfigCommon and ServingCellConfig, etc.), bearer configuration, and measurement configuration associated with ServingCellID or candidateCellID (cell ID associated with physical cell identity (PCI)) may be provided in advance. The corresponding configuration information may be provided in the form of pre-configuration in the RRC configuration, and configuration information for a plurality of candidate cells may be transferred through the RRC configuration. In addition, the corresponding configuration is characterized in that it includes all configuration information (cell configuration, bearer configuration, security key configuration, etc.) applied when the UE moves (handovers) to the corresponding cell. In addition, unified transmission configuration indicator (TCI) state configuration for the candidate cell and configurations related to L1 measurement and report are transferred together with the corresponding configuration. In the following embodiments of the disclosure, particularly in the above-described situation, when the UE performs a handover by receiving a handover message to the target cell through L1/L2 triggered mobility (LTM), the UE performs an operation of automatically synchronizing uplink for the target cell. A more detailed method will be described in the following embodiments.

After the UE 1d-25, which is in an RRC connection state to the serving cell 1 1d-15, is provided with the configurations for TRP 2-Cell 2 1d-20, the UE performs L1 measurement (1d-55) for the corresponding TRP 2-Cell 2 1d-20 according to the received configurations and reports the corresponding results to the serving cell (Cell 1) 1d-15.

If the serving cell 1d-15 determines that a handover is necessary simultaneously with a beam change from the serving cell beam (TCI state 1) 1d-30 to a specific beam (TCI state 2) 1d-40 of TRP 2 (Cell 2) 1d-20 based on the measurement results, the serving cell triggers the beam change and handover and indicates the UE 1d-25 to perform the beam change and handover through L1/L2 signaling (1d-60).

The UE 1d-25 performs the handover simultaneously with a beam change to TRP 2 (Cell 2) 1d-20 through the corresponding indication, and transmits and receives data through the corresponding TRP 2 (Cell 2) 1d-20. In this case, the UE 1d-25 applies the configuration information for the target cell where the handover is performed, which has been previously configured in operation 1d-50. In this case, the UE 1d-25 may perform random access to the target cell or may omit the random access procedure depending on whether uplink synchronization is required. Hereinafter, detailed operations related thereto will be described with reference to the accompanying drawings.

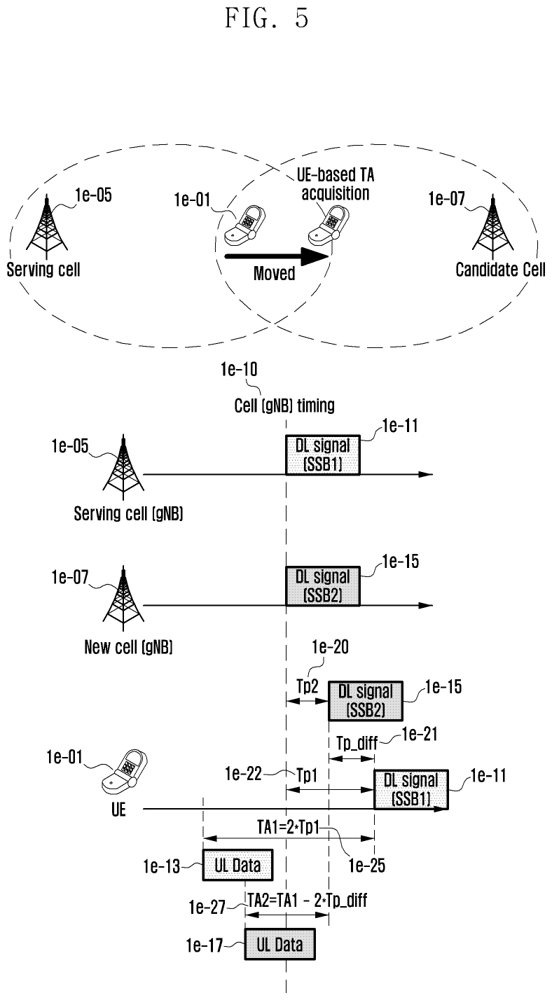

FIG. 5 is a diagram illustrating a scenario in which a UE autonomously updates TA by using received signal time difference of downlink reference signals of a source cell and target cell based on a TA value of a source cell, according to an embodiment of the disclosure.

Referring to FIG. 5, a UE 1e-01 may receive a configuration for LTM (target cell configuration and L1 measurement/report configuration) from a serving cell 1e-05 in an RRC connection state. Then, the UE 1e-01 may perform L1 measurement reporting according to the configuration while moving. Thereafter, the UE 1e-01 may be indicated to perform LTM from the serving cell 1e-05 to the target cell 1e-07. When the UE 1e-01 is indicated to perform LTM to one of the LTM candidate cells, the UE may be indicated to perform UE-based TA acquisition for the corresponding cell. Here, the UE-based TA acquisition refers to an operation in which the UE autonomously updates the TA of the target cell 1e-07 using the received signal time difference (RSTD) of the downlink reference signals (e.g., synchronization signal blocks (SSBs)) of the serving cell 1e-05 and target cell 1e-07 based on the TA value of the serving cell 1e-05. The corresponding operation may be indicated by the serving cell 1e-05 before or together with a cell switch command, or the UE may autonomously perform the operation according to the conditions of the operation based on the RRC configuration.

The operation in which the UE 1e-01 autonomously updates the TA value to be applied in a new cell 1e-07 after the cell switch may be performed as follows.

The UE 1e-01 in a RRC connection state may perform uplink data transmission at TA1 (1e-25), which is a time point that is a certain amount of time earlier than the reception timing of a downlink signal (e.g., SSB1) 1e-11 of the cell 1e-05 within the existing cell 1e-05. This is to match the time point at which the uplink data transmitted by the UE 1e-01 arrives at the base station operating the cell 1e-05 with the timing (1e-10) of the base station. In this case, the TA1 (1e-25) value may be twice the delay time of Tp1 (1e-25) from the actual signal transmitted from the base station to the UE. For reference, the UE 1e-01 may secure the TA value used for uplink data transmission through a random access procedure or reception of a timing advance command (TAC) medium access control (MAC) control element (CE) provided by the base station within the existing cell. In addition, the base station may estimate TP1 (1e-25), which is a signal delay time between the UE 1e-01 and the base station, based on the reception time of the preamble signal transmitted by the UE 1e-01 during a random access procedure or the reception time of the uplink data previously transmitted by the UE 1e-01, and calculate the TA1 value based on the estimated TP1.

In a case where the UE 1e-01 receives a UE-based TA acquisition indication for a new cell 1e-07 from the cell 1e-05, the UE may update the TA value based on the downlink signal reference reception timing of the new cell 1e-07. For reference, in a case where the UE 1e-01 uses the TA value used in the existing serving cell 1e-05 to transmit uplink data within the coverage of the newly selected cell 1e-07, significant interruption may occur in the reception of the uplink signal of the newly selected cell 1e-07. In this case, in a case where the UE 1e-01 performs a separate random access procedure and TAC MAC CE reception to obtain a TA value to be used within the coverage of the new cell 1e-07, an interruption may occur and the time of the handover procedure may be extended. In order to reduce the additional interruption time for TA update in the case of such LTM cell switch, the UE may autonomously update the TA value without the help of the base station. In other words, the UE may perform a UE autonomous TA update operation.

For the UE autonomous TA update described above, the UE 1e-01 may calculate TP_diff (1e-21), which is a difference value between the downlink signal reception timing of the existing cell 1e-05 and the downlink signal reception timing of the new cell 1e-07. In a case where a distance between the actual UE 1e-01 and the new cell 1e-07 and a distance between the UE 1e-01 and the existing cell 1e-05 are different, a signal delay time difference of Tp_diff (1e-21) may occur. The UE 1e-01 may calculate the TA values (TA2, 1e-27) to be used for the uplink transmission (1e-17) in the new cell 1e-07 by using the Tp_diff value and the TA values (TA1, 1e-25) used for the uplink transmission (1e-13) in the existing cell 1e-05, and the UE may autonomously update the TA values used for the uplink transmission. For example, if the downlink signal (1e-15) of the new cell 1e-07 is received at the UE 1e-01 earlier than the downlink signal (1e-11) of the existing cell 1e-05 by Tp_diff (1e-21), this means that the transmission delay time (Tp2, 1e-20) with the new cell 1e-07 is shorter than the transmission delay time (Tp1, 1e-22) with the existing cell 1e-05 by Tp_diff (1e-21) because the UE 1e-01 is closer to the new cell 1e-07 than to the existing cell 1e-05. Therefore, the UE 1e-01 may calculate the Tp_2 value as (Tp1-Tp_diff), and the TA value (TA2, 1e-27) to be used in the coverage of the actual new cell 1e-07 may be calculated as 2*Tp2 (=2*Tp1−2*Tp_diff=TA1−2*Tp_diff).

For reference, the UE autonomous TA update operation described above may be performed assuming that the time synchronization of the existing cell 1e-05 and the new cell 1e-07 is matched. In other words, only under the assumption that the existing cell 1e-05 and new cell 1e-07 transmit the downlink signals (1e-11 and 1e-15) at the same timing, the UE 1e-01 may correctly calculate the Tp_diff (1e-21) value and correctly update the TA value with the new TA values (TA2, 1e-27). If the time synchronization of the existing cell 1e-05 and new cell 1e-07 among the cells existing in the inter distributed unit (DU) is not matched, an additional procedure for correcting this is required.

In the embodiments of the disclosure below, the following considerations may be reflected in relation to the method for obtaining TA from LTM to a target cell based on a UE as described in FIG. 5.
1. First consideration: When UE-based TA acquisition is performed
2. Second consideration: How UE-based TA acquisition is triggered
3. Third consideration: How to compensate for the time mismatch between the source cell and target cell
4. Fourth consideration: How to handle simultaneous configuration of early TA acquisition and UE-based TA acquisition

The disclosure proposes Examples 1, 2, and 3 that have differences while including the above considerations.

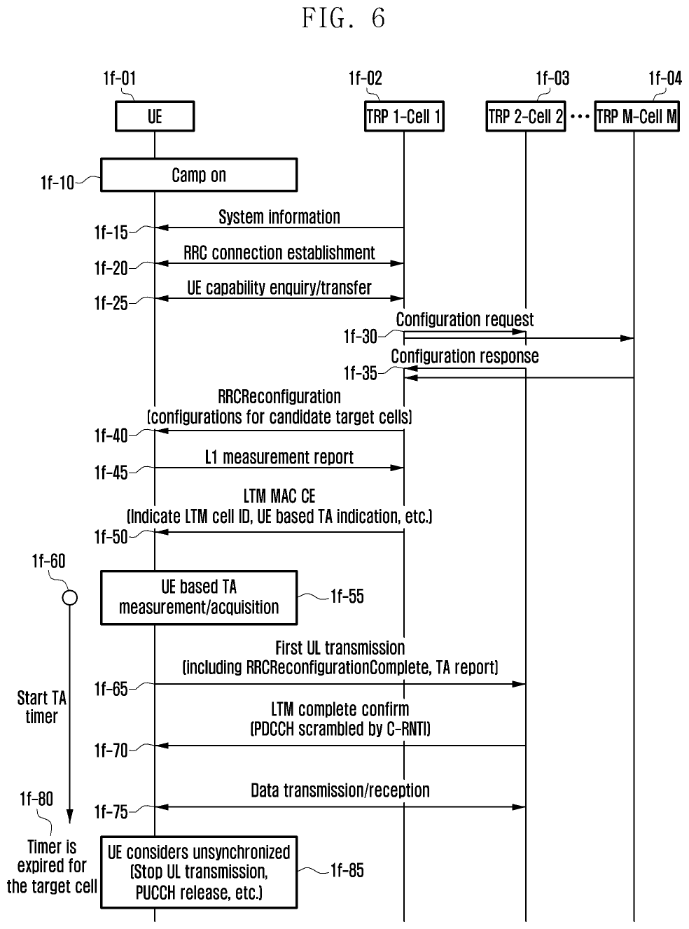

FIG. 6 is a diagram illustrating a procedure for performing UE-based uplink TA acquisition for a target cell when a UE is indicated to perform an LTM cell switch, according to an embodiment of the disclosure.

In particular, the embodiment is characterized in that the UE is indicated to perform an operation of autonomously synchronizing uplink to a target cell, rather than random access, by providing an LTM handover indicator and a command to perform UE-based TA acquisition for the target cell together.

Referring to FIG. 6, a UE 1f-01 receives (1f-15) system information from cell 1 1f-02 in a camp-on state (1f-10), and performs a transition procedure to a connected state (1f-20).

Thereafter, the serving cell 1f-02 requests UE capability to the UE 1f-01 (UE capability enquiry message), and the UE 1f-01 stores the UE capability according to the base station request and transfers the same to the base station 1f-02 (UE capability information message) (1f-25). The corresponding UE capability may include information about whether L1/L2-based inter-cell beam change/management and handover are supported, and the UE capability may also include capability information related to whether the operation of matching UE-based uplink synchronizations for target cells in LTM handover may be supported. The UE 1f-01 transfers information about at least one of UE-specific capability, band-specific capability, and band combination-specific capability to the serving cell 1f-02 through signaling.

The serving cell 1f-02 may request (1f-30) the necessary configuration information in a case where the corresponding UE 1f-01 performs a beam change and handover to neighboring cells 1f-03 and 1f-04 that support L1/L2 triggered mobility, based on L1/L2, and the neighboring cells 1f-03 and 1f-04 include the related configuration information in a response message to the corresponding request and transfer the same to the serving cell 1f-02 (1f-35). In addition, at the corresponding operation, the source cell 1f-02 and neighboring cells 1f-03 and 1f-04 share information about whether to indicate an operation to match UE-based uplink synchronization, and information for correcting a case where the source cell 1f-02 and target candidate cells 1f-03 and 1f-04 do not have time synchronization of downlink reference signals due to different DUs. For example, cell identity (ID), downlink (DL) sync offset information, synchronization signal block (SSB) measurement occasion, etc. may be included in the shared information. In addition, the corresponding information may exist in the LTM candidate cell configuration information, but since the UE must receive and apply the corresponding information in advance, it may exist outside the configuration for the candidate cell and be transferred to the UE as a separate configuration for each target cell, such as LTM L1 measurement configuration (LTM channel state information (CSI) resource configuration). The above 1f-30 and 1f-35 procedures may be applied to request and transfer pre-configuration-related configurations of cells related to L1/L2 inter-cell beam change and handover (LTM) through inter-node RRC message, Xn, F1 interface, etc. In terms of network implementation, in a case where cell 1 1f-02 and neighboring cells 1f-03 and 1f-04 exist in one DU (intra-DU scenario), the corresponding procedures may be omitted.

In a case where the LTM handover is indicated, the UE If-01 may apply a pre-provided configuration for the cell to which the handover is indicated. More specifically, an RRC structure for supporting L1/L2 inter-cell beam change (management) and handover operation, particularly, pre-configuration for candidate neighboring cells, is provided to the UE (1f-40). In operation 1f-40, the serving cell 1f-02 may transfer common/dedicate configuration information, which is applied after L1/L2 triggered mobility (beam change and handover) to neighboring cells 1f-03 and 1f-04 is indicated, to the UE 1f-01. That is, since all configurations related to the corresponding cell applied after the handover must be transferred to the UE 1f-01 in advance, ServingCellID or candidateCellID (cell ID associated with PCI), configuration information corresponding to ServingCellConfigCommon and ServingCellConfig, configurations for Cell group (MAC, RLC, etc.), etc. may also be provided to the UE 1f-01 in advance. The corresponding configuration information may be provided in the form of pre-configuration in the RRC configuration, and configuration information for a plurality of cells and cell groups may be included therein. In addition, the corresponding configuration is characterized in including all configuration information (cell configuration, bearer configuration, security key, measurement configuration, etc.) applied when the UE 1f-01 moves (handovers) to the corresponding cell. In addition, along with the corresponding configuration, unified TCI state configuration, configuration related to L1 measurement and report for LTM candidate cells, and configuration information associated with UE-based TA are transferred. As described above in operations 1f-30 and 1f-35, information associated with the UE-based TA is transferred to the UE 1f-01, which may include an indicator indicating the operation of matching UE-based uplink synchronization and information for correcting a case where the downlink reference signal time synchronization is not matched due to the DUs of the source cell and target candidate cell being different. For example, the correction information may include cell ID, DL sync offset information, SSB measurement occasion, etc. The information associated with the UE-based TA may exist in the LTM candidate cell configuration information, but since the UE must receive and apply the corresponding information in advance, it may exist outside the candidate cell configuration as a separate configuration for each target cell, such as LTM L1 measurement configuration (LTM CSI resource configuration), and be transferred to the UE.

The UE 1f-01 performs measurement on L1 measurement resources for LTM according to the RRC configuration received in operation 1f-40, and reports the measurement result to the base station (serving cell 1f-02) (1f-45). The above L1 measurement report may be a measurement value for LTM candidate cells and is performed according to a scheme configured by the base station (periodic report, aperiodic report, one-time report).

The serving cell 1f-02 may determine the cell change (handover) of the UE based on the L1 measurement result received from the UE 1f-01, and indicates the UE 1f-01 to handover to the target cell (TRP 2-Cell 2) 1f-03 through the MAC (control element) CE indicating LTM (1f-50). The above LTM MAC CE includes the following information:
Target cell index where LTM is performed (candidate cell ID; candidate cell configuration ID)
Active bandwidth part (BWP) ID in a target cell
Indicator indicating whether SCell activation (carrier aggregation) will be performed simultaneously when performing LTM (1 bit or information about activated SCell)
Uplink (UL) grant information (resource for data transmission after LTM in a target cell, for example, resource used for transmitting RRCReconfigurationComplete message)
Beam information used when transmitting in a target cell (TCI state; unified TCI state information)
cell-radio network temporary identity (C-RNTI) used in a target cell
Related to RACH-less handover and uplink TA information (a case where a base station has a TA value of a target cell due to early TA operation)
   Timing Advance Command information: The source cell may transfer a valid TA value to the LTM MAC CE to indicate the UE to perform RACH-less handover to the target cell.
   TA value presence indicator (or RACH/RACH-less indicator): The corresponding information may be transferred as 1 bit, or may be implicitly indicated through another field. In other words, it may be omitted.
      Example 1: In a case where the above TA value is provided in the MAC CE, even if there is no separate RACH/RACH-less indicator, the UE performs RACH-less handover to the target cell by applying the corresponding TA value. In this case, whether the TA value exists or an indicator indicating whether the TA value exists serves as the RACH/RACH-less indicator.
         When indicating the TA value, in a case where 0 is indicated compared to a current reference cell and timing advance group (TAG), the TA value of the corresponding TAG (for example, primary TAG (PTAG)) is applied as is.
         When indicating the TA value, in a case of using an absolute TA value, the TA value of the current TAG (for example, PTAG) is indicated again and transferred.
      Example 2: The TA value presence indicator and the RACH/RACH-less indicator may be separately indicated. This case may be used in a case where the TA value is indicated, but RACH is indicated, etc.
   Information indicating UE-based TA acquisition
      =1 bit indicator
      DL sync offset information (source cell and target cell), omittable.

When receiving LTM MAC CE in operation 1f-50, the UE 1f-01 decodes the corresponding MAC CE and operates according to the configured content. In a case where early TA-related information and UE-based TA information are received together, the UE 1f-01 performs early TA-related operations with priority (or may arbitrarily select a value in terms of UE implementation). Alternatively, when the base station 1f-02 transmits the LTM MAC CE, the priority may be managed so that both are not included in the corresponding content. That is, the base station 1f-02 may indicate the early TA operation with priority over the UE-based TA operation. In this case, only a valid TA value based on the early TA operation may be indicated through the MAC CE.

In particular, in a case where the MAC CE includes information indicating UE-based TA acquisition, the UE If-01 performs the UE-based TA acquisition operation (1f-55). That is, the UE 1f-01 may perform an operation of acquiring the TA value of the target cell 1f-03 by applying the reception time difference between the downlink reference signals of the source cell 1f-02 and target cell 1f-03 based on the TA of the source cell 1f-02. The detailed operation for this is as described above in FIG. 5.

In a case where the TA value for the target cells 1f-03 and 1f-04 is obtained, the UE 1f-01 restarts a TA timer (1f-60). Here, the TA timer may be an existing TA timer, but may be a TA timer newly introduced for UE-based TA. In a case where a new TA timer (TAT) is applied, the value of the new TA timer is configured to be smaller than or equal to the value of the existing TA timer, and when the new TA timer expires, UE-based TA acquisition may be performed. If the UE-based TA acquisition is successful, both the legacy TAT and the new TAT are (re) started, and if the UE-based TA acquisition fails (there is no appropriate cell to measure or accurate UE-based TA acquisition is impossible), no additional operation is performed or the base station 1f-02 may be reported through UL MAC CE or physical uplink control channel (PUCCH). When the legacy TAT expires, the legacy TAT expiration operation is performed. In addition, the disclosure proposes a method for applying priorities instead of having the UE independently perform Legacy TA and UE-based TA measurements. For example, in a case where there are both valid Legacy TA (before Legacy TAT expiration) and valid new TA (before New TAT expiration), the following options are possible with respect to priorities.
Option 1. Legacy TA application
Option 2. New TA application
Option 3. Latest TA application

On the other hand, in a case where only Legacy TA is valid, the UE operates to apply Legacy TA, and in a case where only UE-based TA is valid, the UE applies UE-based TA. In addition, in a case where neither Legacy TA nor UE-based TA is valid (both New TAT and Legacy TAT are expired), the UE performs Legacy TAT expiration operation. As a reference, existing operations when uplink synchronization is not matched, operations such as PUCCH/sounding reference signal (SRS) release and hybrid automatic repeat request (HARQ) buffer flush, may be performed. In this regard, the contents of Table 1 below is referred.

```
TABLE 1
1>when a timeAlignmentTimer expires:
  2> if the timeAlignmentTimer is associated with the PTAG:
3>flush all HARQ buffers for all Serving Cells;
    3>notify RRC to release PUCCH for all Serving Cells, if configured;
    3>notify RRC to release SRS for all Serving Cells, if configured;
    3>clear any configured downlink assignments and configured uplink grants;
    3>clear any PUSCH resource for semi-persistent CSI reporting;
    3>consider all running timeAlignmentTimers as expired;
    3>maintain N_{TA} (defined in TS 38.211 [8]) of all TAGs.
```

The UE 1f-01 performs a handover to the target cell 1f-03 according to the information included in the configuration from the base station, changes the beam to the indicated beam, and performs data transmission and reception through the corresponding beam. At this operation, whether or not to perform a random access for the target cell (TRP 2-Cell 2) 1f-03 may vary depending on whether the UE-based TA acquisition is successful. That is, in a case where the UE-based TA acquisition is successful, the UE 1f-01 skips the random access operation and applies the TA value according to the UE-based TA acquisition to match the uplink synchronization for the corresponding target cell when performing a handover to the target cell. On the other hand, in a case where the UE-based TA acquisition fails, the UE If-01 performs a random access when performing a handover to the target cell.

Here, in a case where the LTM handover ends, the UE If-01 performs a first uplink transmission (RRCReconfigurationComplete message and TA information report) for the LTM target cell (1f-65) and receives a response to the corresponding message (1f-70). The response may be based on one of the following methods:
Option 1: Reception of RLC ACK of RRCReconfigurationComplete message
Option 2: Reception of C-RNTI addressed PDCCH
Option 3: Reception of UE Contention Resolution identity MAC CE

In addition, in the operation 1f-65, the UE If-01 may report the TA value of the target cell obtained as UE-based TA for the first uplink transmission, and the target cell may drive the TA timer in this operation. Here, the UE If-01 may report the obtained TA value using the TA report MAC CE, or may use the newly introduced MAC CE for such reporting. For reference, the above first uplink transmission is transferred through the configured grant resource previously configured in the target cell.

The UE 1f-01 completes the handover with the target cell and may perform data transmission and reception with the corresponding cell (1f-75). In a case where the TA timer that has been already running expires (1f-80) during data communication with the target cell, the UE If-01 determines that the uplink synchronization with the target cell is not matched, and performs operations such as physical uplink control channel (PUCCH)/sounding reference signal (SRS) release and HARQ buffer flush (1f-85), which are operations performed when the existing uplink synchronization is not matched. For operations related to this, the contents of Table 1 described above are referred.

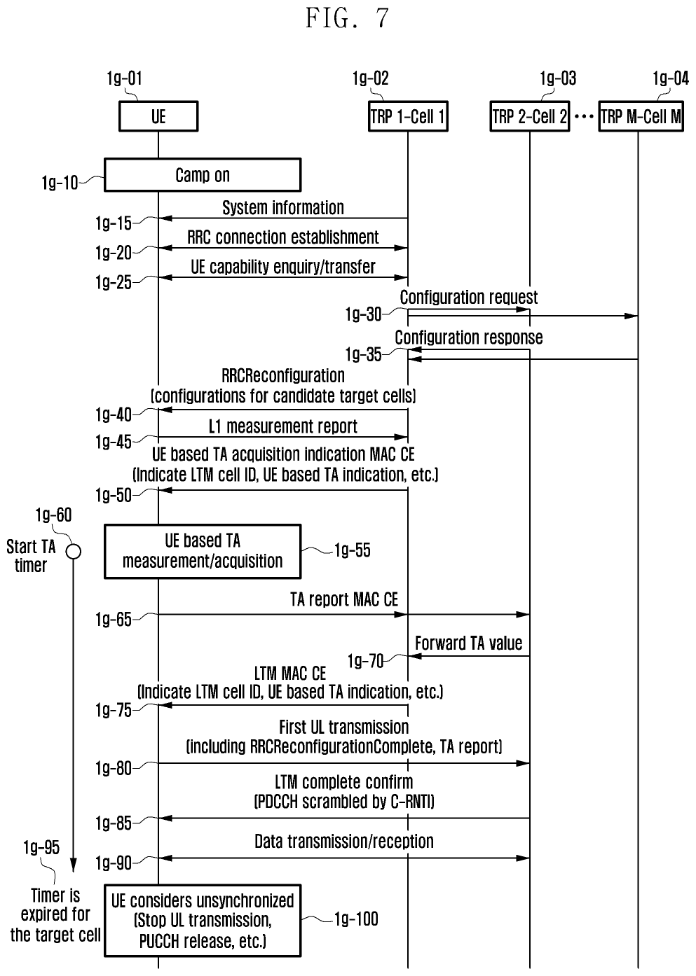

FIG. 7 is a diagram illustrating a procedure in which a UE is indicated to perform UE-based uplink TA acquisition for a target cell before the UE is indicated with LTM cell switch, according to an embodiment of the disclosure.

In particular, the embodiment is characterized in that the UE is indicated to perform an operation of autonomously synchronizing uplink to a target cell, rather than random access, by providing the UE with a command to perform UE-based TA acquisition for the target cell before transmitting an MAC CE indicating LTM handover.

Referring to FIG. 7, a UE 1g-01 receives (1g-15) system information from cell 1 1g-02 in a camp-on state (1g-10), and performs a transition procedure to a connected state (1g-20).

Thereafter, the serving cell 1g-02 requests UE capability to the UE 1g-01 (UE capability enquiry message), and the UE 1g-01 stores the UE capability according to the request of the base station 1g-02 and transfers the same to the base station 1g-02 (UE capability information message) (1g-25). The corresponding UE capability may include information about whether L1/L2-based inter-cell beam change/management and handover are supported, and the UE capability may also include capability information related to whether the operation of matching UE-based uplink synchronizations for target cells in LTM handover may be supported. The UE 1g-01 transfers information about at least one of UE-specific capability, band-specific capability, and band combination-specific capability, as UE capability, to the base station 1g-02 through signaling.

The serving cell 1g-02 may request (1g-30) the configuration information necessary for the beam change and handover in a case where the UE 1g-01 performs a beam change and handover to neighboring cells 1g-03 and 1g-04 that support L1/L2 triggered mobility, based on L1/L2, and the neighboring cells 1g-03 and 1g-04 include the requested configuration information in a response message to the corresponding request and transfer the same to the serving cell 1g-02 (1g-35). In addition, at the operations of 1g-30 and 1g-35, the source cell 1g-02 and neighboring cells 1g-03 and 1g-04 share information about whether to indicate an operation to match UE-based uplink synchronization, and information for correcting a case where the downlink reference signal time synchronization is not matched due to the DUs of the source cell 1g-02 and target candidate cell being different. For example, cell ID, DL sync offset information, SSB measurement occasion, etc. may be included in the shared information. In addition, the corresponding information may exist in the LTM candidate cell configuration information, but since the UE must receive and apply the corresponding information in advance, it may exist outside the candidate cell configuration and be transferred to the UE as UE capability as a separate configuration for each target cell, such as the LTM L1 measurement configuration (LTM CSI resource configuration). The above procedures of 1g-30 and 1g-35 be used to request and transfer pre-configuration-related configurations of cells related to L1/L2 inter-cell beam change and handover (LTM) via inter-node RRC message, Xn, F1 interface, etc. In terms of network implementation, in a case where cell 1 1g-02 and neighboring cells 1g-03 and 1g-04 exist in one DU (intra-DU scenario), the procedures of 1g-30 and 1g-35 may be omitted.

In a case where the LTM handover is indicated, the UE 1g-01 may apply a pre-provided configuration for the cell to which the handover is indicated. More specifically, an RRC structure for supporting L1/L2 inter-cell beam change (management) and handover operation, particularly, pre-configuration for candidate neighboring cells, is provided to the UE 1g-01 (1g-40). In operation 1g-40, the serving cell 1g-02 may transfer common/dedicate configuration information, which is applied after L1/L2 triggered mobility (beam change and handover) to neighboring cells 1g-03 and 1g-04 is indicated, to the UE 1g-01. That is, since all configurations of the corresponding cell applied after the handover must be transferred to the UE 1g-01 in advance, ServingCellID or candidateCellID (cell ID associated with PCI), configuration information corresponding to ServingCellConfigCommon and ServingCellConfig, configurations for Cell group (MAC, RLC, etc.), etc. may also be provided to the UE 1g-01 in advance. The corresponding configuration information may be provided in the form of pre-configuration in the RRC configuration, and configuration information for a plurality of cells and cell groups may be included therein. In addition, the corresponding configuration is characterized in including all configuration information (cell configuration, bearer configuration, security key, measurement configuration, etc.) applied when the UE 1g-01 moves (handovers) to the corresponding cell. In addition, along with the corresponding configuration, unified TCI state configuration, configuration related to L1 measurement and report for LTM candidate cells, and configuration information associated with UE-based TA are transferred. As described above in operations 1g-30 and 1g-35, information associated with the UE-based TA is transferred to the UE 1g-01, which may also include an indicator indicating the operation of matching UE-based uplink synchronization and information for correcting a case where the downlink reference signal time synchronization is not matched due to the DUs of the source cell and target candidate cell being different. For example, the correction information may include cell ID, DL sync offset information, SSB measurement occasion, etc. In addition, the corresponding information may exist in the LTM candidate cell configuration information, but since the UE must receive and apply the corresponding information in advance, it may exist outside the candidate cell configuration as a separate configuration for each target cell, such as LTM L1 measurement configuration (LTM CSI resource configuration), and be transferred to the UE.

The UE 1g-01 performs measurement on L1 measurement resources for LTM according to the RRC configuration received in operation 1g-40, and reports the measurement result to the base station (serving cell 1g-02) (1g-45). The above L1 measurement report may include a measurement value for LTM candidate cells and is performed according to a scheme configured by the base station (periodic report, aperiodic report, one-time report).

The serving cell 1g-02 transfers to the UE 1g-01 a MAC CE (new MAC CE, extended logical channel ID (eLCID)) indicating UE-based TA acquisition for specific candidate target cells through information about whether UE-based TA acquisition may be performed from candidate target cells (1g-50). Here, the corresponding signaling may be transmitted through PDCCH order. The MAC CE includes a cell ID performing UE-based TA acquisition and UE-based TA acquisition indication and related information.
Information indicating UE-based TA acquisition
   Cell information (ID)
   =1 bit indicator
   DL sync offset information (source cell and target cell), omittable
   SSB measurement resource location information

In operation 1g-50, the UE 1g-01, which has received the UE-based TA acquisition indication MAC CE (or PDCCH order), decodes the corresponding MAC CE and operates according to the configured content. In a case where early TA-related information and UE-based TA request are received together, both requests may be performed or the UE 1f-01 performs early TA-related operations with priority (or may arbitrarily select a value in terms of UE implementation). Alternatively, when the base station 1g-02 transmits the LTM MAC CE, the priority may be managed so that both requests are not included in the corresponding content. That is, the base station may indicate the early TA operation with priority over the UE-based TA operation.

The UE 1g-01 performs the UE-based TA acquisition operation (1g-55). That is, the UE 1g-01 performs an operation of acquiring the TA value of the target cell 1g-03 by applying the reception time difference between the downlink reference signals of the source cell 1g-02 and target cell 1g-03 based on the TA of the source cell 1g-02. The detailed operation for this is as described above in FIG. 5.

In a case where the UE 1g-01 obtains the TA value for the target cells later, the UE 1g-01 restarts a TA timer (1g-60). Here, the TA timer may be an existing TA timer, but may be a TA timer newly introduced for UE-based TA. If a new TA timer (TAT) is configured to be smaller than or equal to the existing TA timer, and when the new TA timer expires, the UE 1g-01 may perform UE-based TA acquisition. If the UE-based TA acquisition is successful, both the legacy TAT and the new TAT are (re) started, and if the UE-based TA acquisition fails (a case where there is no appropriate cell to measure or accurate UE-based TA acquisition is impossible), no additional operation is performed or the above failure may be reported to the base station through UL MAC CE or PUCCH. When the legacy TAT expires, the legacy TAT expiration operation is performed. In addition, the Example proposes a method for applying priorities instead of having the UE independently perform Legacy TA and UE-based TA measurements. In a case where there are both valid Legacy TA (before Legacy TAT expiration) and valid new TA (before New TAT expiration), the following options are possible with respect to priorities.
Option 1. Legacy TA application
Option 2. New TA application
Option 3. Latest TA application

On the other hand, in a case where only Legacy TA is valid, Legacy TA is applied, and in a case where only UE-based TA is valid, UE-based TA is applied. In addition, in a case where both Legacy TA and UE-based TA are invalid (both New TAT and Legacy TAT are expired), Legacy TAT expiration operation is performed. For reference, existing operations when uplink synchronization is not matched, operations such as PUCCH/SRS release and HARQ buffer flush, may be performed. For this, the contents of Table 1 described above are referred.

In addition, if a TA value is obtained through UE-based TA acquisition in the above operation, the UE 1g-01 may transfer the obtained TA value to the base station through TA report MAC CE. Here, the UE 1g-01 may report the obtained TA value using the TA report MAC CE, or a new MAC CE may be introduced for this purpose. The obtained TA value may be transferred to the source cell 1g-02, or may be transferred to the target cell 1g-03 to which the corresponding TA is applied. In a case where the obtained TA value is transferred to the target cell 1g-03, the target cell 1g-03 forwards the corresponding information to the source cell 1g-02 (1g-70). In addition, in a case where there is no resource for forwarding this information, the UE 1g-01 triggers a scheduling request (SR) to receive an uplink grant. Alternatively, in a case where there is a significant difference between the Legacy TA (the value given in the TA Command) and the UE-based TA according to the value obtained by the UE 1g-01 through the UE-based TA procedure, the UE may report this using the TA report MAC CE. Alternatively, as described above, after obtaining the corresponding TA value, or when handing over to the target cell, the obtained TA value may always be reported.

The serving cell 1g-02 may determine the cell change (handover) of the UE 1g-01 based on the L1 measurement result received from the UE 1g-01, and indicates the UE to handover to the target cell (TRP 2-Cell 2) 1g-03 through the MAC CE indicating LTM (1g-75). The above LTM MAC CE includes the following information:
Target cell index where LTM is performed (candidate cell ID; candidate cell configuration ID)
Active BWP ID in a target cell
Indicator indicating whether SCell activation (carrier aggregation) will be performed simultaneously when performing LTM (1 bit or information about activated SCell)
Uplink (UL) grant information (resource for data transmission after LTM in a target cell, for example, resource used for transmitting RRCReconfigurationComplete message)
Beam information used when transmitting in a target cell (TCI state; unified TCI state information)
C-RNTI used in a target cell
Related to RACH-less handover and uplink TA information (a case where a base station has a TA value of a target cell due to early TA operation)
Timing Advance Command information: The source cell may transfer a valid TA value to the LTM MAC CE to indicate the UE to perform RACH-less handover to the target cell.
TA value presence indicator (or RACH/RACH-less indicator): The corresponding information may be transferred as 1 bit, or may be implicitly indicated through another field. In other words, it may be omitted.
   Example 1: In a case where the above TA value is provided in the MAC CE, even if there is no separate RACH/RACH-less indicator, the UE performs RACH-less handover to the target cell by applying the corresponding TA value. In this case, whether the TA value exists or an indicator indicating whether the TA value exists serves as the RACH/RACH-less indicator.
      When indicating the TA value, in a case where 0 is indicated compared to a current reference cell and TAG, the TA value of the corresponding TAG (for example, PTAG) is applied as is.
      When indicating the TA value, in a case of using an absolute TA value, the TA value of the current corresponding TAG (for example, PTAG) is indicated again and transferred.
   Example 2: The TA value presence indicator and RACH/RACH-less indicator may be separately indicated. This case may be used in a case where the TA value is indicated, but RACH is indicated, etc.
Information indicating UE-based TA acquisition application=
   1 bit indicator
   DL sync offset information (source cell and target cell), omittable

The UE 1g-01 performs a handover to the target cell 1g-03 according to the information included in the LTM MAC CE, changes the beam to the indicated beam, and performs data transmission and reception through the corresponding beam. In this operation, whether to perform a random access for the target cell (TRP 2-Cell 2) 1g-03 may vary depending on whether the LTM MAC CE indicates a TA value and whether a RACH-less handover is indicated. For example, in a case where the LTM MAC CE indicates a TA value and a RACH-less handover, the UE 1g-01 may skip the random access operation and apply the indicated TA value for uplink synchronization to the corresponding target cell when performing a handover to the target cell. In contrast, if the LTM MAC CE does not indicate a TA value and a RACH-less handover, the UE 1g-01 performs a random access when performing a handover to the target cell 1g-03.

Here, in a case where the LTM handover ends, the UE 1g-01 transfers (1g-80) a first uplink transmission (RRCReconfigurationComplete message and TA information report) to the LTM target cell 1g-03 and receives (1g-85) a response to the corresponding message. The response method may be one of the following methods.
Option 1: Reception of RLC ACK of RRCReconfigurationComplete message
Option 2: Reception of C-RNTI addressed PDCCH
Option 3: Reception of UE Contention Resolution identify MAC CE

In addition, in the operation 1g-80, the UE 1g-01 may report the TA value of the target cell obtained as the UE-based TA for the first uplink transmission, and the target cell 1g-03 may have already received the TA value in the procedure described above. The target cell 1g-03 may also start the TA timer in this operation. Here, the UE 1g-01 may report the TA value using the TA report MAC CE, or a new MAC CE may be introduced for this purpose. For reference, the first uplink transmission is transferred through the configured grant resource previously configured in the target cell.

The UE 1g-01 may complete the handover with the target cell 1g-03 and perform data transmission and reception with the corresponding cell (1g-90). During data communication with the target cell, in a case where the TA timer that has been already running expires (1g-95), the UE 1g-01 determines that the uplink synchronization with the target cell is not matched, and thus, as the existing operation when the uplink synchronization is not matched, perform operations such as PUCCH/SRS release, HARQ buffer flush, etc. (1g-100). For the operations related to this, the contents of Table 1 described above is referred.

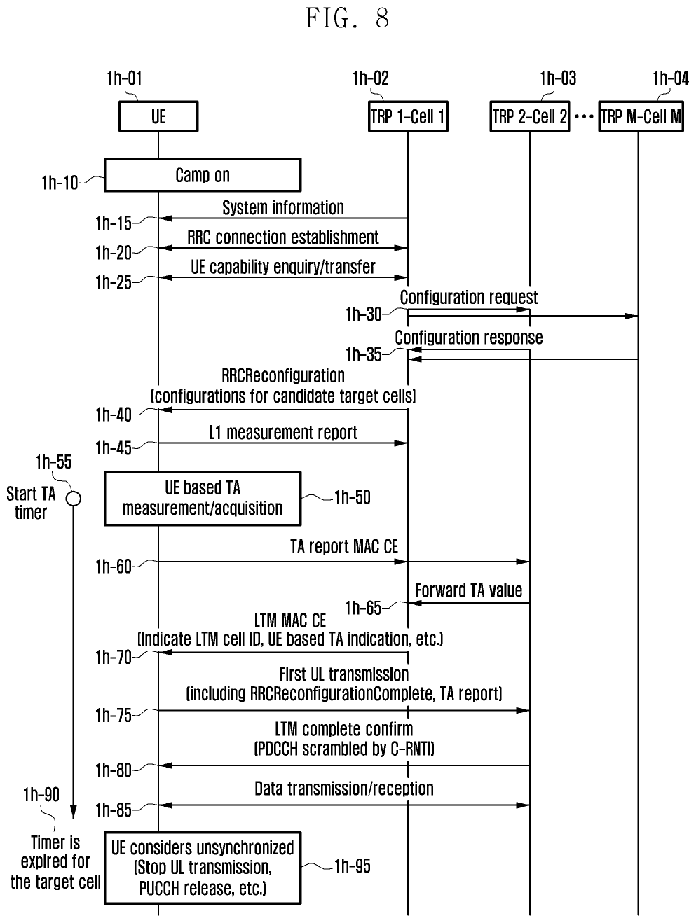

FIG. 8 is a diagram illustrating a procedure in which a UE performs UE-based uplink TA acquisition for a target cell according to a previously configured condition before the UE is indicated with LTM cell switch, according to an embodiment of the disclosure.

A UE 1h-01 receives (1h-15) system information from cell 1 1h-02 in a camp-on state (1h-10), and performs a transition procedure to a connected state (1h-20). Thereafter, the serving cell 1h-02 requests UE capability to the UE 1h-01 (UE capability enquiry message), and the UE 1h-01 stores the UE capability according to the base station request and transfers the same to the base station 1h-02 (UE capability information message) (1h-25). The corresponding UE capability may include information about whether L1/L2-based inter-cell beam change/management and handover are supported, and the UE capability may also include capability information related to whether the operation of matching UE-based uplink synchronizations for target cells in LTM handover may be supported. The UE 1h-01 transfers information about at least one of UE-specific capability, band-specific capability, and band combination-specific capability, as UE capability, to the base station 1h-02 through signaling.

The serving cell 1h-02 may request (1h-30) the configuration information necessary for the beam change and handover in a case where the corresponding UE performs a beam change and handover to neighboring cells 1h-03 and 1h-04 that support L1/L2 triggered mobility, based on L1/L2, and the neighboring cells 1h-03 and 1h-04 include the requested configuration information in a response message to the corresponding request and transfer the same (1h-35). In addition, at the operation of 1h-30 and 1h-35, the source cell 1h-02 and neighboring cells 1h-03 and 1h-04 share information about whether to indicate an operation to match UE-based uplink synchronization, and information for correcting a case where the downlink reference signal time synchronization is not matched due to the DUs of the source cell and target candidate cell being different. For example, cell ID, DL sync offset information, SSB measurement occasion, etc. may be included in the shared information. In addition, the corresponding information may exist in the LTM candidate cell configuration information, but since the UE must receive and apply the corresponding information in advance, it may exist outside the configuration for the candidate cell and be transferred to the UE 1h-01 as a separate configuration for each target cell, such as LTM L1 measurement configuration (LTM CSI resource configuration). The above procedures of 1h-30 and 1h-35 may be used to request and transfer pre-configuration-related configurations of cells related to L1/L2 inter-cell beam change and handover (LTM) via inter-node RRC message, Xn, F1 interface, etc. In terms of network implementation, in a case where cell 1 1h-02 and neighboring cells 1h-03 and 1h-04 exist in one DU (intra-DU scenario), the procedures of 1h-30 and 1h-35 may be omitted.

In a case where the LTM handover is indicated, the UE 1h-01 may apply a pre-provided configuration for the cell to which the handover is indicated. More specifically, an RRC structure for supporting L1/L2 inter-cell beam change (management) and handover operation, particularly, pre-configuration for candidate neighboring cells, is provided to the UE 1h-01 (1h-40). In operation 1h-40, the serving cell 1h-02 may transfer common/dedicate configuration information, which is applied after L1/L2 triggered mobility (beam change and handover) to neighboring cells 1h-03 and 1h-04 is indicated, to the UE 1h-01. That is, since all configurations of the corresponding cell applied after the handover must be transferred to the UE 1h-01 in advance, ServingCellID or candidateCellID (cell ID associated with PCI), configuration information corresponding to ServingCellConfigCommon and ServingCellConfig, configurations for cell group (MAC, RLC, etc.), etc. may also be provided to the UE 1h-01 in advance. The corresponding configuration information may be provided in the form of pre-configuration in the RRC configuration, and configuration information for a plurality of cells and cell groups may be included therein. In addition, the corresponding configuration is characterized in including all configuration information (cell configuration, bearer configuration, security key, measurement configuration, etc.) applied when the UE 1h-01 moves (handovers) to the corresponding cell. In addition, along with the corresponding configuration, unified TCI state configuration, configuration related to L1 measurement and report for LTM candidate cells, and configuration information associated with UE-based TA are transferred. As described above in operations 1h-30 and 1h-35, information associated with the UE-based TA is transferred to the UE 1h-01, which may also include an indicator indicating the operation of matching UE-based uplink synchronization and information for correcting a case where the downlink reference signal time synchronization is not matched due to the DUs of the source cell and target candidate cell being different. For example, the correction information may include cell ID, DL sync offset information, SSB measurement occasion, etc. In addition, the corresponding information may exist in the LTM candidate cell configuration information, but since the UE must receive and apply the corresponding information in advance, it may exist outside the candidate cell configuration as a separate configuration for each target cell, such as LTM L1 measurement configuration (LTM CSI resource configuration), and be transferred to the UE 1h-01.

The UE 1h-01 performs measurement on L1 measurement resources for LTM according to the RRC configuration received in operation 1h-40, and reports the measurement result to the base station (serving cell 1h-02) (1h-45). The above L1 measurement report may include a measurement value for LTM candidate cells and is performed according to a scheme configured by the base station (periodic report, aperiodic report, one-time report).

The UE 1h-01 performs a UE-based TA acquisition operation for the corresponding target cell when a specific condition is satisfied according to the UE-based TA acquisition related configurations in the operation 1h-40 (or immediately performed in a case where there is a UE-based TA acquisition indicator for the target cell in the configurations) (1h-50). The specific condition may be, for example, a case where a reference signal timing difference (RSTD) between a downlink reference signal received from the target cell and a downlink reference signal of the source cell exists within a preconfigured range. Alternatively, whether the specific condition is satisfied may be determined by comparing the RSTD with a preconfigured threshold value. Here, performing UE-based TA acquisition based on the RSTD existing within a specific range according to the above preconfigured threshold value means that if the RSTD is so small as not to be included in the specific range, a change in the TA value is so small that the existing TA value may be applied as is, and thus, UE-based TA acquisition will not be performed; and if the RSTD is so large as not to be included in the specific range, the TA change is so large compared to the current source cell that an error in the TA value obtained by the UE-based TA acquisition may be large, and thus, UE-based TA acquisition will not be performed. In addition, in addition to the above-described RSTD-based triggering condition, the UE-based TA acquisition operation may also be determined based on the condition on the signal strength as follows. This is because in a case where the signal strength is less than a predetermined threshold value, an error in the UE-based TA estimation may be large, and thus, it would be appropriate not to perform the UE-based TA acquisition.
Signal strength triggering method 1: When the signal strength of at least one target cell is greater than or equal to a threshold (because the TA measurement accuracy may decrease if the target cell signal is too low)
Signal strength triggering method 2: When the signal strength of the source cell is greater than or equal to a threshold or less than or equal to a threshold
Signal strength triggering method 3: When the conditions considering both the signal strength of the source and the signal strength of the target cell are satisfied (e.g., the signal strength of the source cell is greater than or equal to a first threshold & the signal strength of the target cell is greater than or equal to a second threshold)

In the above operation, in a case where the UE 1h-01 performs UE-based TA acquisition from a plurality of target cells and obtains a TA value, the corresponding value is maintained and managed for each candidate target cell. In a case where the UE 1h-01 obtains a TA value for a target cell, the TA timer is restarted (1h-55). Here, the TA timer may be an existing TA timer, but may be a TA timer newly introduced for UE-based TA. If a new TA timer (TAT) is configured to be less than or equal to an existing TA timer, and when the new TA timer expires, the UE 1h-01 may perform UE-based TA acquisition. If UE-based TA acquisition is successful, both legacy TAT and new TAT are (re) started, and if UE-based TA acquisition fails (a failure case because there is no suitable cell to measure or accurate UE-based TA acquisition is not possible), the UE 1h-01 may not perform any further operation or may report the failure to the base station via UL MAC CE or PUCCH. When the legacy TAT expires, the UE 1h-01 performs the legacy TAT expiration operation. In addition, this example also proposes a method for applying priority instead of performing the legacy TA and UE-based TA measurement operations independently. In a case where there are both a valid legacy TA (before Legacy TAT expiration) and a valid new TA (before new TAT expiration), the following options are possible with respect to priorities.
Option 1. Legacy TA application
Option 2. New TA application
Option 3. Latest TA application

On the other hand, in a case where only Legacy TA is valid, Legacy TA is applied, and in a case where only UE-based TA is valid, UE-based TA is applied. In addition, in a case where both Legacy TA and UE-based TA are invalid (both new TAT and Legacy TAT are expired), Legacy TAT expiration operation is performed. As a reference, existing operations when uplink synchronization is not matched, such as PUCCH/SRS release and HARQ buffer flush, may be performed. In this regard, the contents of Table 1 described above are referred.

In addition, if the TA value is obtained through UE-based TA acquisition in the above operation, the UE 1h-01 may transfer the obtained TA value to the base station through TA report MAC CE (1h-60). Here, the UE 1h-01 may report using TA report MAC CE or use the newly introduced MAC CE for this purpose. The obtained TA value may be transferred to the source cell 1h-02, or may be transferred to the target cell 1h-03 to which the corresponding TA is applied. In a case where the obtained TA value is transferred to the target cell 1h-03, the target cell 1h-03 forwards the corresponding information to the source cell 1h-02 (1h-65). In addition, in a case where the UE 1h-01 does not have a resource to forward this information, the UE triggers SR to receive an uplink grant. Alternatively, in a case where the UE 1h-01 has a significant change between the Legacy TA (a value given in the TA Command) and the UE-based TA based on the value obtained by the UE-based TA procedure, the UE may report this using TA report MAC CE. Alternatively, as described above, the obtained TA value may always be reported after obtaining the corresponding TA value or when handing over to the target cell.

The serving cell 1h-02 may determine the cell change (handover) of the UE 1h-01 based on the L1 measurement result received from the UE 1h-01, and indicates the UE 1h-01 to handover to the target cell (TRP 2-Cell 2) 1h-03 through the MAC CE indicating LTM (1h-70). The above LTM MAC CE includes the following information:
Target cell index where LTM is performed (candidate cell ID; candidate cell configuration ID)
Active BWP ID in a target cell
Indicator indicating whether SCell activation (carrier aggregation) will be performed simultaneously when performing LTM (1 bit or information about activated SCell)
UL grant information (resource for data transmission after LTM in a target cell, for example, resource used for transmitting RRCReconfigurationComplete message)
Beam information used when transmitting in a target cell (TCI state; unified TCI state information)
C-RNTI used in a target cell
Related to RACH-less handover and uplink TA information (a case where a base station has a TA value of a target cell due to early TA operation)
   Timing Advance Command information: The source cell may transfer a valid TA value to the LTM MAC CE to indicate the UE to perform RACH-less handover to the target cell.
   TA value presence indicator (or RACH/RACH-less indicator): The corresponding information may be transferred as 1 bit, or may be implicitly indicated through another field. In other words, it may be omitted.
      Example 1: In a case where the above TA value is provided in the MAC CE, even if there is no separate RACH/RACH-less indicator, the UE performs RACH-less handover to the target cell by applying the corresponding TA value. In this case, whether the TA value exists or an indicator indicating whether the TA value exists serves as the RACH/RACH-less indicator.
         When indicating the TA value, in a case where 0 is indicated compared to a current reference cell and TAG, the TA value of the corresponding TAG (for example, PTAG) is applied as is.
         When indicating the TA value, in a case of using an absolute TA value, the TA value of the current corresponding TAG (for example, PTAG) is indicated again and transferred.
      Example 2: The TA value presence indicator and RACH/RACH-less indicator may be separately indicated. This case may be used in a case where the TA value is indicated, but RACH is indicated, etc.
Information indicating UE-based TA acquisition application
   1 bit indicator
   DL sync offset information (source cell and target cell), omittable

The UE 1h-01 performs a handover to the target cell 1h-03 according to the information included in the MAC CE indicating the LTM, changes the beam to the indicated beam, and performs data transmission and reception through the corresponding beam. In this operation, whether to perform a random access for the target cell (TRP 2-Cell 2) 1h-03 may vary depending on whether the LTM MAC CE indicates a TA value and whether a RACH-less handover is indicated. For example, in a case where the LTM MAC CE indicates a TA value and a RACH-less handover, the UE 1h-01 may skip the random access operation and apply the indicated TA value for uplink synchronization to the corresponding target cell 1h-03 when performing a handover to the target cell 1h-03. In contrast, if the LTM MAC CE does not indicate a TA value and a RACH-less handover, the UE 1h-01 performs a random access when performing a handover to the target cell 1h-03. Here, in a case where the LTM handover ends, the UE 1h-01 transfers (1h-75) a first uplink transmission (RRCReconfigurationComplete message and TA information report) to the LTM target cell and receives (1h-80) a response to the corresponding message. The response method may be one of the following methods.
Option 1: Reception of RLC ACK of RRCReconfigurationComplete message
Option 2: Reception of C-RNTI addressed PDCCH
Option 3: Reception of UE Contention Resolution identify MAC CE

In addition, in the operation 1h-75, the UE 1h-01 may report the TA value of the target cell obtained as the UE-based TA for the first uplink transmission, and the target cell 1h-03 may have already received the corresponding TA value in the procedure described above. The target cell 1h-03 may also start the TA timer in this operation. Here, the UE 1h-01 may report the TA value of the target cell using the TA report MAC CE, or a new MAC CE may be introduced for this purpose. For reference, the first uplink transmission is transferred through the configured grant resource previously configured in the target cell.

The UE 1h-01 may complete the handover with the target cell 1h-03 and perform data transmission and reception with the corresponding cell (1h-85). During data communication with the target cell 1h-03, in a case where the TA timer that has been already running expires (1h-90), the UE 1h-01 determines that the uplink synchronization with the target cell 1h-03 is not matched (1h-95), and thus, as the existing operation when the uplink synchronization is not matched, perform operations such as PUCCH/SRS release, HARQ buffer flush, etc. For the operations related to this, the contents of Table 1 described above is referred.

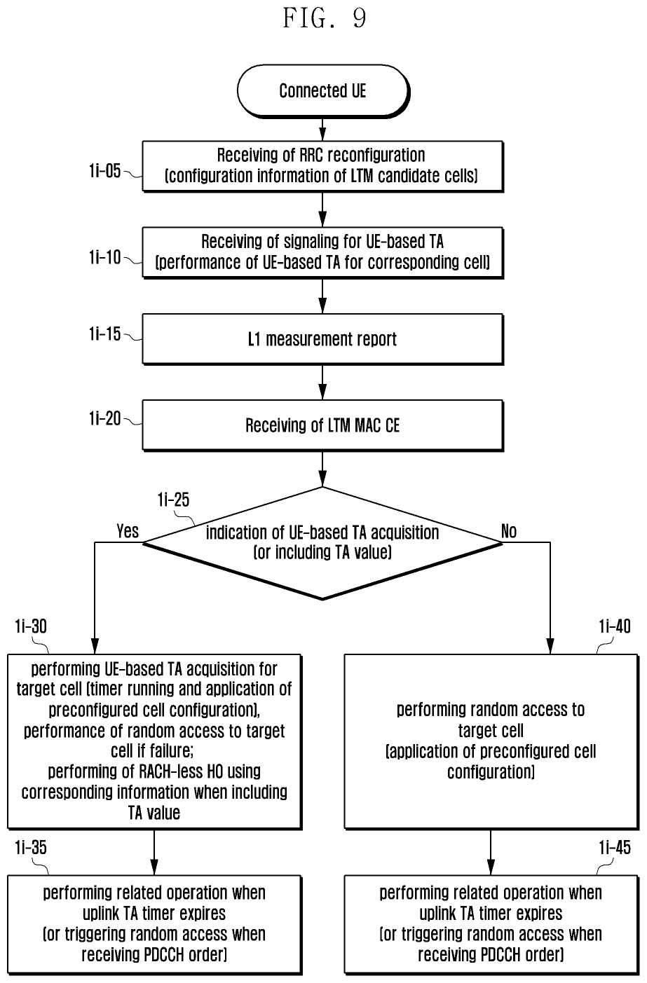

FIG. 9 is a diagram illustrating a UE operation according to an embodiment of the disclosure.

In operation 1i-05, a UE in a connected state may receive, from a serving cell, common/dedicate configuration information for neighboring cells applied after L1/L2 triggered mobility is indicated via an RRC reconfiguration message. For detailed configuration methods and contents, the contents of the above-described embodiments are referred.

The UE that has received the corresponding configuration receives signaling (UE autonomous triggering according to MAC CE or PDCCH order or RRC configuration) indicating a UE-based TA acquisition operation in operation 1i-10, and the corresponding signaling may include an indicator indicating that UE-based TA should be performed, an index for an LTM candidate cell, DL sync offset information, etc. In this operation, in a case where the UE obtains a TA value through the UE-based TA, the UE may report the obtained TA value to a base station (a source cell or target cell). For reference, the corresponding operation corresponds to the operations of Examples 2 and 3 described in the disclosure, and as in Example 1, the related operation may be performed together with the operation being indicated in the LTM MAC CE of operation 1i-20 in the drawing.

In operation 1i-15, the UE performs L1 resource measurement and reporting according to the L1 measurement measuring and reporting configurations for the configured LTM candidate cells.

In operation 1i-20, the UE receives the LTM MAC CE, and performs different subsequent operations depending on whether any values are indicated in the corresponding signaling. In particular, the operation is different depending on whether the LTM MAC CE includes an indicator indicating whether to perform random access (RACH-less handover indication), a UE-based TA acquisition indicator, or a valid TA value (1i-25).

In a case where the corresponding LTM MAC CE includes a UE-based TA acquisition indicator, the UE performs a UE-based TA acquisition operation for the target cell indicated in operation 1i-30, and in a case where the corresponding operation succeeds and a valid TA value is obtained, the UE performs a RACH-less handover operation to the target cell. In a case where the corresponding operation fails and a valid TA value is not obtained, the UE performs a random access to the target cell. In addition, in a case where a valid TA value is indicated, the UE performs a RACH-less handover operation to the target cell by applying the corresponding value. In this case, a timer is driven and the corresponding cell configuration preconfigured via RRC is applied. In this case, a valid TA value for the target cell for which a handover is performed is transferred to the LTM MAC CE, and if the corresponding TA value is applied, the random access process may be omitted, so that the uplink interruption time may be significantly reduced. In addition, for example, the current serving cell and the target cell may have the same uplink synchronization, and in cases where they belong to the same DU, the base station may indicate the corresponding TA value as 0 or set the RACH-less handover indicator to true to indicate the same to the UE. That is, such an operation may be indicated on the premise that the base station has the same synchronization for the target cell and serving cell, and in this case, the UE applies the uplink synchronization in the serving cell as it is. Alternatively, a specific serving cell and timing advance group (TAG) index may be transferred together, and such an operation may be indicated through the reference cell and TAG.

In operation 1i-35, the UE performs the timer expiration operation described in the above embodiments when the uplink TA timer expires. For example, the UE performs operations such as PUCCH/SRS release, HARQ buffer flush, etc. Alternatively, in this operation, a random access may be triggered to obtain a new uplink synchronization by receiving a PDCCH order from the base station before the uplink TA timer expires.

In operation 1i-25, in a case where the UE determines that the LTM MAC CE from the base station does not include a valid TA value, a RACH-less handover indicator, or a UE-based TA acquisition indicator, the UE performs a handover by performing a random access operation to the target cell indicated in operation 1i-40. In addition, when handing over to the target cell, the configurations for the corresponding cell preconfigured by the base station are applied. Since random access is also performed in this operation, the UE may obtain a valid TA value after the random access to the target cell (via RAR or TA command MAC CE) and performs an operation to maintain the corresponding value according to the TA timer preconfigured in RRC.

In addition, in operation 1i-45, the UE performs an existing uplink TA timer expiration operation when the uplink TA timer expires. For example, the UE performs operations such as PUCCH/SRS release, HARQ buffer flush, etc. Alternatively, in this operation, a random access may be triggered to obtain a new uplink synchronization by receiving a PDCCH order from the base station before the uplink TA timer expires.

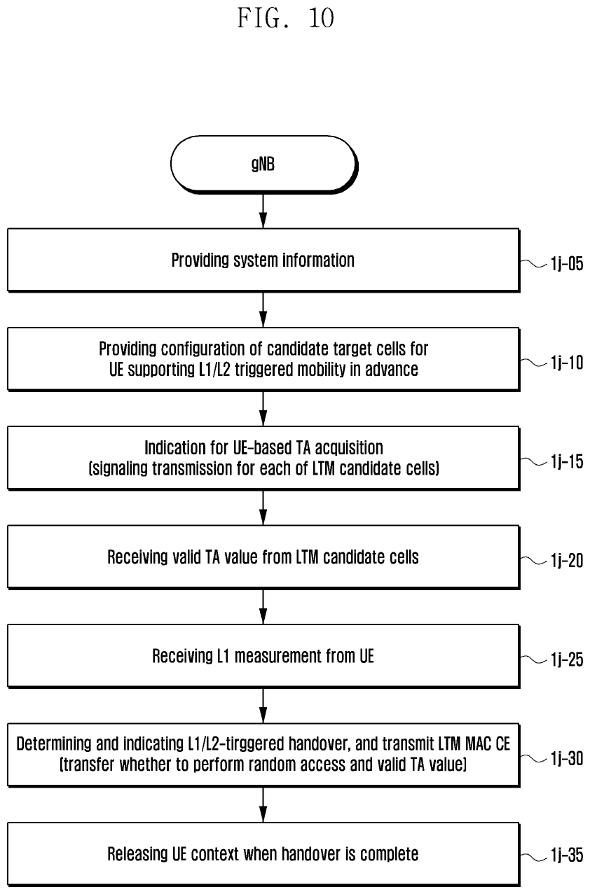

FIG. 10 is a diagram illustrating a base station operation according to an embodiment of the disclosure.

In operation 1j-05, the base station provides system information to the UE, and in operation 1j-10, the base station transfers, to the UE in connected state, common/dedicate configuration information for the neighboring cells applied after L1/L2 triggered mobility is indicated from the serving cell via an RRC reconfiguration message. For detailed configuration methods and contents, the contents of FIG. 4 and FIG. 6 described above are referred. In particular, the disclosure is characterized in that among the configuration information for cells to which L1/L2 handover is applied, the corresponding configuration includes early TA-related configuration and indications for performing uplink synchronization for candidate cells in advance.

In the corresponding operation, the base station may perform coordination related to whether LTM configuration UE-based TA acquisition is supported with the neighboring LTM candidate cells. This may be performed through Xn, F1 interface, inter-node RRC message (CG-ConfigInfo, CG-Config), etc. Thereafter, in operation 1j-15, the source base station (serving cell) transfers, to the UE, signaling for triggering the UE-based TA procedure for LTM candidate cells that require UE-based TA. The signaling may be included in the LTM MAC CE and transferred to the UE.

Thereafter, in operation 1j-25, the L1 measurement value is received from the UE, and the measurement value may be a report on a neighboring cell (non-serving cell) that supports L1/L2 triggered mobility, i.e., an LTM candidate cell.

Based on the measurement result received from the UE, the serving cell may determine whether to change the beam of the UE and whether to perform a handover. If it is determined that a change and handover to a specific beam of a neighboring cell is necessary rather than a specific beam of the serving cell, the base station indicates the UE to change the cell and beam via the LTM MAC CE in operation 1j-30. In the corresponding operation, whether to perform a random access for the cell where the handover occurs, transfer of a valid TA value, UE-based TA indication, etc. may be indicated via L1/L2 signaling.

In a case where a handover is indicated, the serving cell performs a handover procedure, and in operation 1j-35, when the handover with the target cell is completed, the UE context is deleted and the connection with the UE is released. The above is characterized in that the measurement value used for determining whether to perform a handover is an L1 measurement. In addition, operations 1j-15 and 1j-20 may occur as needed. That is, in a case where the base station determines that the TA value with the UE is invalid, the corresponding operations may be newly triggered to reobtain the TA. Conversely, the base station may omit the early TA procedure for the purpose of triggering random access even if the TA value is determined to be invalid for a specific LTM candidate cell. In this case, the base station may indicate an LTM handover through signaling, such as not including a valid TA value in the LTM MAC CE and indicating a RACH-less handover indicator as false.

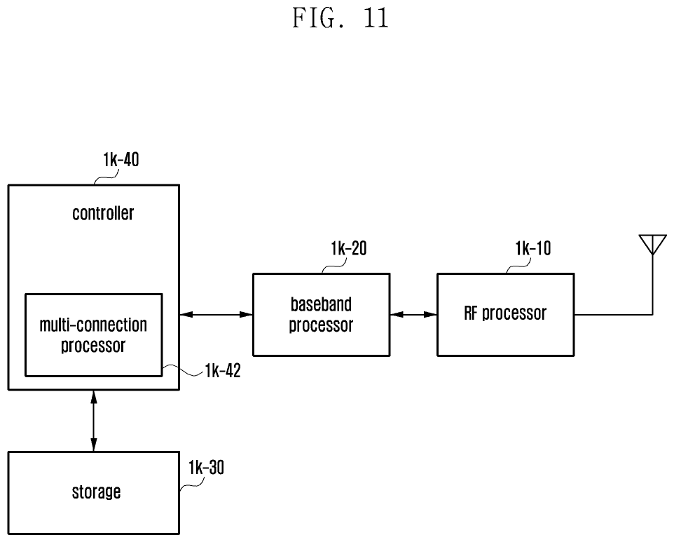

FIG. 11 is a block diagram of an internal structure of a UE according to an embodiment of the disclosure.

Referring to FIG. 11, a UE according to the disclosure includes a radio frequency (RF) processor 1k-10, a baseband processor 1k-20, a storage 1k-30, and a controller 1k-40.

The RF processor 1k-10 performs functions for transmitting/receiving signals through a wireless channel, such as signal band conversion, amplification, and the like. That is, the RF processor 1k-10 up-converts a baseband signal provided from the baseband processor 1k-20 into an RF band signal, transmits the same through an antenna, and down-converts an RF band signal received through the antenna into a baseband signal. For example, the RF processor 1k-10 may include a transmission filter, a reception filter, an amplifier, a mixer, an oscillator, a digital to analog converter (DAC), an analog to digital converter (ADC), and the like. Although only one antenna is illustrated in the diagram, the UE may include multiple antennas. In addition, the RF processor 1k-10 may include multiple RF chains. Moreover, the RF processor 1k-10 may perform beamforming. For the sake of the beamforming, the RF processor 1k-10 may adjust the phase and magnitude of signals transmitted/received through multiple antennas or antenna elements. In addition, the RF processor may perform MIMO, and may receive multiple layers when performing the MIMO operation.

The baseband processor 1k-20 performs a function of conversion between a baseband signal and a bit string according to the physical layer specification of the system. For example, during data transmission, the baseband processor 1k-20 encodes and modulates a transmission bit string, thereby generating complex symbols. In addition, during data reception, the baseband processor 1k-20 demodulates and decodes a baseband signal provided from the RF processor 1k-10, thereby restoring a reception bit string. For example, in a case where an orthogonal frequency division multiplexing (OFDM) scheme is followed, during data transmission, the baseband processor 1k-20 encodes and modulates a transmission bit string so as to generate complex symbols, maps the complex symbols to subcarriers, and then constitutes OFDM symbols through an inverse fast Fourier transform (IFFT) operation and cyclic prefix (CP) insertion. In addition, during data reception, the baseband processor 1k-20 divides a baseband signal provided from the RF processor 1k-10 in an OFDM symbol unit, restores signals mapped to subcarriers through a fast Fourier transform (FFT) operation, and then restores the reception bit string through demodulation and decoding.

The baseband processor 1k-20 and RF processor 1k-10 transmit and receive signals as described above. Accordingly, the baseband processor 1k-20 and RF processor 1k-10 may be referred to as transmitter, receiver, transceiver, or communication units. In addition, at least one of the baseband processor 1k-20 and the RF processor 1k-10 may include multiple communication modules in order to support multiple different radio access technologies. Furthermore, at least one of the baseband processor 1k-20 and the RF processor 1k-10 may include different communication modules in order to process signals in different frequency bands. For example, the different radio access technologies may include a wireless LAN (e.g., IEEE 802.11), cellular networks (e.g., LTE), etc. In addition, the different frequency bands may include a super high frequency (SHF) (for example, 2.NRHz, NRhz) band and a millimeter wave (for example, 60 GHZ) band.

The storage 1k-30 stores data for operation of the UE, such as a basic program, an application program, and configuration information. In particular, the storage 1k-30 may store information related to a second access node that performs wireless communication using a second wireless access technology. Further, the storage 1k-30 provides stored data at a request of the controller 1k-40.

The controller 1k-40 controls the overall operations of the UE. For example, the controller 1k-40 receives/transmits signals through the baseband processor 1k-20 and the RF processor 1k-10. In addition, the controller 1k-40 records and reads data in the storage 1k-30. To this end, the controller 1k-40 may include at least one processor. For example, the controller 1k-40 may include a communication processor (CP) that performs control for communication, and an application processor (AP) that controls the higher layer, such as an application program.

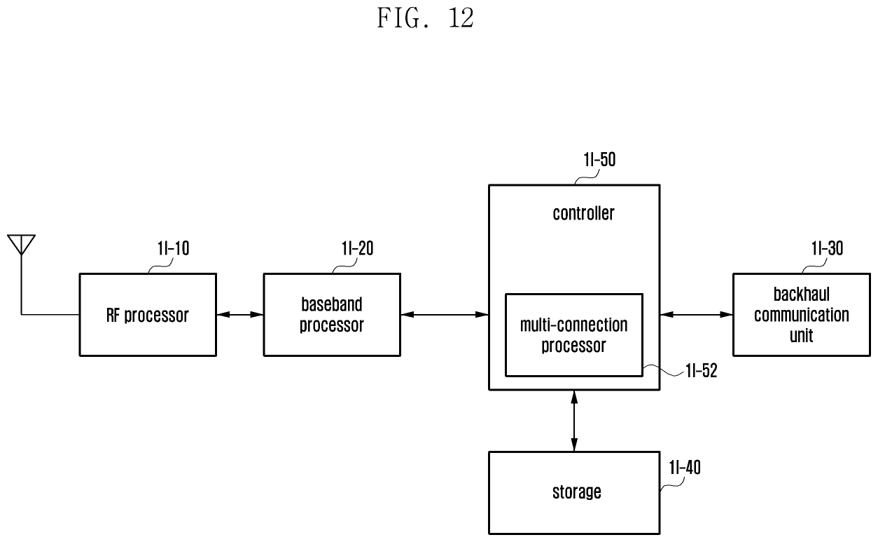

FIG. 12 is a block diagram illustrating a constitution of a base station according to an embodiment of the disclosure.

Referring to FIG. 12, a base station according to the disclosure is constituted to include an RF processor 11-10, a baseband processor 11-20, a backhaul communication unit 11-30, a storage 11-40, and a controller 11-50.

The RF processor 11-10 performs functions for transmitting/receiving signals through a wireless channel, such as signal band conversion, amplification, and the like. That is, the RF processor 11-10 up-converts a baseband signal provided from the baseband processor 11-20 into an RF band signal, transmits the same through an antenna, and down-converts an RF band signal received through the antenna into a baseband signal. For example, the RF processor 11-10 may include a transmission filter, a reception filter, an amplifier, a mixer, an oscillator, a DAC, an ADC, and the like. Although only one antenna is illustrated in the diagram, the first access node may include multiple antennas. In addition, the RF processor 11-10 may include multiple RF chains. Moreover, the RF processor 11-10 may perform beamforming. For the sake of the beamforming, the RF processor 11-10 may adjust the phase and magnitude of signals transmitted/received through multiple antennas or antenna elements. The RF processor may perform a downlink MIMO operation by transmitting one or more layers.

The baseband processor 11-20 performs a function of conversion between a baseband signal and a bit string according to the physical layer specification of the first radio access technology. For example, during data transmission, the baseband processor 11-20 encodes and modulates a transmission bit string, thereby generating complex symbols. In addition, during data reception, the baseband processor 11-20 demodulates and decodes a baseband signal provided from the RF processor 11-10, thereby restoring a reception bit string. For example, in a case where an OFDM scheme is followed, during data transmission, the baseband processor 11-20 encodes and modulates a transmission bit string so as to generate complex symbols, maps the complex symbols to subcarriers, and then constitutes OFDM symbols through an IFFT operation and CP insertion. In addition, during data reception, the baseband processor 11-20 divides a baseband signal provided from the RF processor 11-10 in an OFDM symbol unit, restores signals mapped to subcarriers through a FFT operation, and then restores the reception bit string through demodulation and decoding. The baseband processor 11-20 and RF processor 11-10 transmit and receive signals as described above. Accordingly, the baseband processor 11-20 and RF processor 11-10 may be referred to as transmitter, receiver, transceiver, communication unit, wireless communication unit.

The backhaul communication unit 11-30 provides an interface for communicating with other nodes inside the network. That is, the backhaul communication unit 11-30 converts a bit string transmitted from the main base station to another node, for example, an auxiliary base station or a core network, into a physical signal, and converts a physical signal received from the other node into a bit string.

The storage 11-40 stores data for operation of the main base station, such as a basic program, an application program, and configuration information. Particularly, the storage 11-40 may store information regarding a bearer allocated to an accessed UE, a measurement result reported from the accessed UE, and the like. In addition, the storage 11-40 may store information serving as a criterion to determine whether to provide the UE with multi-connection or to discontinue the same. In addition, the storage 11-40 provides stored data at a request of the controller 11-50.

The controller 11-50 controls the overall operations of the main base station. For example, the controller 11-50 receives/transmits signals through the baseband processor 11-20 and the RF processor 11-10, or through the backhaul communication unit 11-30. In addition, the controller 11-50 records and reads data in the storage 11-40. To this end, the controller 11-50 may include at least one processor.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station, layer 1/layer 2 triggered mobility (LTM) configuration information including a configuration for at least one candidate cell via a radio resource control (RRC) message, wherein the configuration includes information associated with UE-based timing advance (TA) measurement configured for a candidate cell;
identifying that the UE-based TA measurement is configured for the candidate cell of the at least one candidate cell, based on the information;
receiving, from the base station, a medium access control (MAC) control element (CE) indicating a LTM cell switch, the MAC CE including first information indicating a configuration identity (ID) of the candidate cell for the LTM cell switch and second information on a timing advance command;
identifying whether a valid timing advance (TA) value is indicated based on the timing advance command; and
in case that the valid TA value is indicated based on the timing advance command, applying the TA value for the LTM cell switch to the candidate cell.

2. The method of claim 1, further comprising:
performing a TA measurement based on the identification that the UE-based TA measurement is configured for the candidate cell;
obtaining a TA value based on the TA measurement; and
in case that the valid TA value is not indicated by the timing advance command, applying the obtained TA value for the LTM cell switch to the candidate cell.

3. The method of claim 2, further comprising:
starting a time alignment timer associated with the candidate cell,
wherein the TA measurement is performed before a reception of the MAC CE, and
wherein the information includes an ID for identifying a cell for which the UE-based TA measurement is performed.

4. The method of claim 2,
wherein a random access channel (RACH)-less procedure is performed for the LTM cell switch to the candidate cell, and
wherein the LTM cell switch to the candidate cell is completed, in case that first uplink data is transmitted to the candidate cell successfully.

5. The method of claim 1, further comprising:
receiving, from the base station, a UE capability enquiry message; and
transmitting, to the base station, a UE capability information message including information indicating that the UE supports the UE-based TA measurement.

6. A method performed by a base station in a wireless communication system, the method comprising:
transmitting, to a user equipment (UE), layer 1/layer 2 triggered mobility (LTM) configuration information including a configuration for at least one candidate cell via a radio resource control (RRC) message, wherein the configuration includes information associated with UE-based timing advance (TA) measurement configured for a candidate cell; and
transmitting, to the UE, a medium access control (MAC) control element (CE) indicating a LTM cell switch, the MAC CE including first information indicating a configuration identity (ID) of the candidate cell for the LTM cell switch and second information on a timing advance command,
wherein the UE-based TA measurement is configured with the UE for the candidate cell of the at least one candidate cell based on the information, and
wherein, in case that a valid timing advance (TA) value is indicated based on the timing advance command, the valid TA value is applied by the UE for the LTM cell switch to the candidate cell.

7. The method of claim 6, wherein in case that the valid TA value is not indicated by the timing advance command, a TA value obtained in the UE based on a TA measurement is applied for the LTM cell switch to the candidate cell.

8. The method of claim 7, further comprising:
obtaining the valid TA value based on an early TA acquisition procedure performed before a transmission of the MAC CE,
wherein the information includes an ID for identifying a cell for which the UE-based TA measurement is performed.

9. The method of claim 6, further comprising:
transmitting, to the at least one candidate cell, a first message for requesting the configuration of the at least one candidate cell for the LTM cell switch; and
receiving, from the at least one candidate cell, a second message including the configuration of the at least one candidate cell, as a response to the first message.

10. The method of claim 6, further comprising:
transmitting, to the UE, a UE capability enquiry message; and
receiving, from the UE, a UE capability information message including information indicating that the UE supports the UE-based TA measurement.

11. A user equipment (UE) in a wireless communication system, the UE comprising:
a transceiver; and
a controller configured to:
control the transceiver to receive, from a base station, layer 1/layer 2 triggered mobility (LTM) configuration information including a configuration for at least one candidate cell via a radio resource control (RRC) message, wherein the configuration includes information associated with UE-based timing advance (TA) measurement configured for a candidate cell,
identify that the UE-based TA measurement is configured for the candidate cell of the at least one candidate cell, based on the information,
control the transceiver to receive, from the base station, a medium access control (MAC) control element (CE) indicating a LTM cell switch, the MAC CE including first information indicating a configuration identity (ID) of the candidate cell for the LTM cell switch and second information on a timing advance command,
identify whether a valid timing advance (TA) value is indicated based on the timing advance command, and
in case that the valid TA value is indicated based on the timing advance command, apply the TA value for the LTM cell switch to the candidate cell.

12. The UE of claim 11, wherein the controller is further configured to:
perform a TA measurement based on the identification that the UE-based TA measurement is configured for the candidate cell,
obtain a TA value based on the TA measurement, and
in case that the valid TA value is not indicated by the timing advance command, apply the obtained TA value for the LTM cell switch to the candidate cell.

13. The UE of claim 12,
wherein the controller is further configured to start a time alignment timer associated with the candidate cell,
wherein the TA measurement is performed before a reception of the MAC CE, and
wherein the information includes an ID for identifying a cell for which the UE-based TA measurement is performed.

14. The UE of claim 12,
wherein a random access channel (RACH)-less procedure is performed for the LTM cell switch to the candidate cell, and
wherein the LTM cell switch to the candidate cell is completed, in case that first uplink data is transmitted to the candidate cell successfully.

15. The UE of claim 11, wherein the controller is further configured to:
control the transceiver to receive, from the base station, a UE capability enquiry message, and
control the transceiver to transmit, to the base station, a UE capability information message including information indicating that the UE supports the UE-based TA measurement.

16. A base station in a wireless communication system, the base station comprising:
a transceiver; and
a controller configured to:
control the transceiver to transmit, to a user equipment (UE), layer 1/layer 2 triggered mobility (LTM) configuration information including a configuration for at least one candidate cell via a radio resource control (RRC) message, wherein the configuration includes information associated with UE-based timing advance (TA) measurement configured for a candidate cell, and
control the transceiver to transmit, to the UE, a medium access control (MAC) control element (CE) indicating a LTM cell switch, the MAC CE including first information indicating a configuration identity (ID) of the candidate cell for the LTM cell switch and second information on a timing advance command,
wherein the UE-based TA measurement is configured with the UE for the candidate cell of the at least one candidate cell based on the information, and
wherein, in case that a valid TA value is indicated based on the timing advance command, the valid TA value is applied by the UE for the LTM cell switch to the candidate cell.

17. The base station of claim 16, wherein in case that the valid TA value is not indicated by the timing advance command, a TA value obtained in the UE based on a TA measurement is applied for the LTM cell switch to the candidate cell.

18. The base station of claim 17,
wherein the controller is further configured to obtain the valid TA value based on an early TA acquisition procedure performed before a transmission of the MAC CE, and
wherein the information includes an ID for identifying a cell for which the UE-based TA measurement is performed.

19. The base station of claim 16, wherein the controller is further configured to:
control the transceiver to transmit, to the at least one candidate cell, a first message for requesting the configuration of the at least one candidate cell for the LTM cell switch, and
control the transceiver to receive, from the at least one candidate cell, a second message including the configuration of the at least one candidate cell, as a response to the first message.

20. The base station of claim 16, wherein the controller is further configured to:
control the transceiver to transmit, to the UE, a UE capability enquiry message, and
control the transceiver to receive, from the UE, a UE capability information message including information indicating that the UE supports the UE-based TA measurement.
